(19) United States
(12) Patent Application Publication
(10) Pub. No.: US 2012/0082306 A1
(43) Pub. Date: Apr. 5, 2012

(54) Data Encryption and Input System

(76) Inventor: Andrew William Hulse, Medina, TX (US)

(21) Appl. No.: 13/252,994

(22) Filed: Oct. 4, 2011

Related U.S. Application Data
(60) Provisional application No. 61/390,115, filed on Oct. 5, 2010.
(60) Provisional application No. 61/434,805, filed on Jan. 20, 2011.
(60) Provisional application No. 61/444,627, filed on Feb. 18, 2011.

(51) Int. Cl. H04L 9/28; H04L 9/32

(52) U.S. Cl. 380/28

(57) ABSTRACT

A method of encrypting and inputting data by creating a relationship between a predetermined indicator key and the data to be passed on is presented. In the preferred embodiment, one or more data encryption dials are presented, each with a compartmentalized ring containing numerical data values. At least one compartmentalized ring containing indicator keys is also positioned on the encryption dial which can be rotated into apposition with the numerical data values. When data values are entered, the interface uses the data value that is in apposition with the predetermined indicator key as the data value to be passed on to a data receiving system. Upon submission of the first data value, the positions of the indicator keys and numerical data values change randomly before allowing the user to use the encryption dials to submit the second data value.

The current application claims priority to U.S. Provisional Patent application Ser. No. 61/390,115 filed on Oct. 5, 2010, U.S. Provisional Patent application Ser. No. 61/434,805 filed on Jan. 20, 2011, and U.S. Provisional Patent application Ser. No. 61/444,627 filed on Feb. 18, 2011.

### FIELD OF THE INVENTION

The present invention relates generally to data encryption and, more particularly, to encrypting and entering alpha and numeric data, credit card numbers, special characters, passwords, pin numbers, personal or corporate information, and any other sensitive characters and or data into a computerized system, a computerized device, a personal computer, smart phone, computer tablet, an Internet Website, or an Automated Teller Machine.

### BACKGROUND OF THE INVENTION

With advancements in electronics and the computer industry and with the increasing popularity of the Internet, consumers are increasingly storing and accessing more and more of their sensitive personal and business information on the Internet, on Automated Teller Machines, on computerized systems and on networks. This information, such as credit card numbers, CVC numbers from the back of credit cards, phone numbers, addresses, bank and credit card account information, Social Security numbers, birthdays, credit ratings, emails, address lists, email recipient lists, photographs, patents, home movies, passwords, pin numbers, and even information on family members, is generally governed and protected by a user id and password or a pin number on a computer or website that may or may not be encrypted. The prototypical method for entering such information is to type the information on a physical keyboard or to use mouse clicks on a virtual keyboard to enter the information. Key-logger programs and some spyware programs have contributed to the rise in both identity theft and online theft. Covertly loaded key-logger programs are specifically written to record keystrokes from a keyboard as they are being entered into a computer or website. With a key-logger program, computer hackers or identity thieves are able to read credit card numbers and other information because the key-logger programs record the strokes of the keyboard directly onto the computer's hard drive while it is being uploaded to the host, and then the key-logger programs present the stolen information to the host that covertly loaded the key-logger program. Another method commonly employed by identity thieves is simply to look over a consumer's shoulder while the consumer is typing or keying the password or pin unto a computer keyboard or A.T.M. keypad. Some thieves resort to using the video record function on their cell phones to make a short video of a consumer's hands as the desired information is entered. Well practiced identity thieves will pretend to be talking on the phone as they video tape both the number on the face of a check debit card and the pin number as it is being keyed onto the keypad.

Although websites, computer networks, computerized systems, and Automated Teller Machines may be encrypted for protecting this information after it is entered, this information may be stolen by computer hackers or thieves while it is being entered. Historically, the best defense for protection against key-logger programs is to install an anti-virus and anti-spyware program for identifying key-logger programs and spy-ware programs as they are loaded onto the computer. A solution to the problem of identity thieves observing the physical typing of passwords and pins is for the host company to partially cover the keyboard or keypad so that the keys are no longer visible to another person.

Encrypted websites do an excellent job of protecting information once it is uploaded to the website; however, these encrypted website do nothing to protect passwords, pin numbers, etc. while they are being typed into the computer or onto a keypad. The anti-virus and anti-spyware solution is not a perfect solution to the problem as the computer hackers and identity thieves are constantly writing new key-logger and spy-ware programs and then uploading them to the internet. So, anti-virus and spy-ware software programs are in daily need of being updated with new definitions to defeat the newest threats. If a new key-logger or spy-ware program gets covertly loaded onto a computer before the anti-virus and anti-spyware definitions are updated, then a theft of information is likely. Likewise, the solution of partially covering the keyboard or keypad only makes it more difficult for thieves to watch or video record the transaction or the typing of the passwords. In other words, identity thieves and computer hackers are likely to adapt their tactics. The current invention protects against both of these specific threats and other threats as well.

The main objective of the present invention is to provide a reliable device for consumers and users to use to encrypt and input passwords, pins numbers, credit card numbers, and or any other personal or corporate information into a computerized system, Personal Computer, ATM, or Internet Website in a discrete, covert, and camouflaged manner so that even if a non-user observes the process, the non-user would not be able to decipher the encrypted data because of the volume of indicator keys. Furthermore, randomization of the indicator keys, after each individual encryption and input event, prevents non-users from replicating the exact sequence of encryption even if they physically observe the encryption process or if they abscond with the encrypted data by means of computer hacking or by means of a key-logger program.

Another advantage of the present invention is that the data encryption process can easily be configured into a game so that users actually play a game while encrypting and inputting their passwords. Since the encryption is accomplished by bringing the position of the valid indicator keys in apposition to the data values targeted for encryption, the data encryption and input system can be converted into a game to be played on the computer screen. This is possible since the indicator keys and data values can be housed in a variety of shapes.

### SUMMARY OF THE INVENTION

A business method that allows users to encrypt and input data such as pins, passwords, user IDs, credit card numbers, Social Security numbers, check debit card numbers, phone numbers, addresses, and typed text, by using a software program that turns one or more Data Encryption Dials, is presented. Although the data dials are the preferred embodiment, the method may be expressed in a variety of ways, and the method will be expressed as a software program. The program displays the dials on a computer monitor or on any type of viewing screen that runs the software program on a computerized system. Each dial contains two or more concentric compartmentalized rings that contain either data selected for encryption and data not selected for encryption, or that contain indicator keys, some of which will have been pre-designated by the user prior to use for the purpose of identifying the data for encryption from non-targeted data. For example, a four-digit pin number with numerical digits used to access an account on an Automated Teller Machine running the encryption software would have four numerical digits that would become target data which would be encrypted and inputted to the ATM pin-pad screen by the user turning the Data Encryption Dial so as to align the target data with pre-designated indicator keys. Users must first pre-select an indicator key or a sequence of indicator keys out of many indicator keys with the host to serve as valid indicator keys, and users then turn one or more of the dials until the data which the users is targeting for encryption is brought into apposition with or lined up with the valid indicator key. Users then mouse click or push the enter button to encrypt and input all the data from all rings on all the dials. Even invalid indicator keys and non-target data is upload so as to provide the encryption. The host uses the valid indicator keys to decrypt or decipher the data which was uploaded for encryption and input by the user. Only the user and the host know which indicator keys are valid and which are not valid. It is advisable for the host to require the users to use more than one valid indicator key. By using two or more valid indicator keys, the possibility of fraudulent activity by non-users is reduced. The ideal usage would have a new valid indicator key required after each data encryption and input event, but to do this, users would be required to predesignate a sequence of valid indicator keys that would equal the number of characters in the password, pin number, credit card number and so on. If the ideal usage is required by the host for the user to have one valid indicator key for each character to be encrypted and if the user has a four-digit pin number to be entered, then the user would have to designate four Indicator keys, which would become valid indicator keys. Additionally, all indicator keys, whether valid or invalid, and or data values are shuffled and randomized by the software program after each data input event. Randomization adds another layer of protection. Only one indicator key is valid per concentric ring. Thus, the configuration that uses two compartmentalized rings of indicator keys, will have one valid indicator key for each ring. Users need to turn both dials to align both the valid indicator keys from their respective rings with the data being targeted for encryption, which will be loaded in the middle ring. Non-valid indicator keys point to non-selected data values which are not targeted for encryption and input but which are being inputted to add additional complexity to the encryption system.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of a data encryption dial with one outer compartmentalized ring loaded with indicator keys, one middle compartmentalized ring loaded with data values, and one inner compartmentalized ring loaded with an additional set of indicator keys. This data encryption dial is configured to work on a fictional bank's website, which is displaying the dial prior to the first data encryption and input event.

FIG. 2 is a front view of a continuation of FIG. 1 as it is the same data encryption dial configured for the website of the same fictional bank but after the first character of the password had been encrypted and inputted and after the positions of the indicator keys have been shuffled and randomized so that the dial is ready for the next encryption and input event.

FIG. 3 is a front view of a data encryption dial configured for the display screen of an automated teller machine with dial ready for the first data encryption and input event.

FIG. 4 is a front view of a continuation of FIG. 3 as the same data encryption dial configured for an automated teller machine yet after the first pin digit has been encrypted and inputted and after the indicator key positions have been shuffled and randomized but prior to the second data encryption and input event.

FIG. 5 is a front view of a data encryption device configured to operate as the sign in page of an internet website while using a non-circular configuration with a counter clockwise circulation of the indicator keys prior to the first data encryption event.

FIG. 6 is a front view of a continuation of FIG. 5 as the same data encryption device but after the first character of the password had been encrypted and inputted to the host website and after the positions of the indicator keys had been shuffled and randomized. The device is ready for the second character of the password.

FIG. 7 is a front view of a data encryption device comprising a set of four data encryption dials configured to operate as the sign-in page of an internet website. All four dials rotate simultaneously as the user presses a dial rotation trigger button. Each encryption dial has an outer compartmentalized ring of numbers and an inner compartmentalized ring of indicator keys.

FIG. 8 is a front view of a data encryption device configured to operate as the sign in page of an internet website utilizing a game-style interface where the user shoots bullet shells with numerical digits towards a plurality of targets with indicator keys.

FIG. 9 is a visual illustration showing a relationship between a counter pin, also known as the indicator key, and a pin number to be inputted into a login interface. In such an embodiment, a four-digit pin number requires four different indicator keys. The predetermined indicator key changes after each pin number entry.

FIG. 10 is a visual illustration showing a possible relationship between a predetermined valid indicator key and the target data value to be passed to the login interface. In such an embodiment, the indicator key and target data value are brought into apposition in order for the relationship to be formed.

FIG. 11 is another visual illustration showing a possible relationship between a predetermined valid indicator key and the target data value to be passed to the login interface. In such an embodiment, the indicator key and target data value are linked together by the user in order for the relationship to be formed.

FIG. 12 is yet another visual illustration showing a possible relationship between a predetermined valid indicator key and the target data value to be passed to the login interface. In such an embodiment, either the indicator key or the target data value is moved towards the other. Without actual contact or a physical link between the two, merely moving the indicator key or the target data value towards the other will establish a relationship between the two to determine the target data to be passed.

FIG. 13 is a visual illustration showing an interface in which the user must enter in a 16-digit credit card number. For each sequential digit of the credit card number, the user must use a unique predetermined indicator key. As it may be difficult to memorize a series of 16 predetermined indicator keys, the indicator keys form a memorable phrase. As shown, the sequence of 16 indicator keys forms the phrase ‘Jack Loves Jill Now’.

FIG. 14 is a front view of a special feature of the data encryption device in which the display interface is shown on a computerized screen, but the user must use the numerical codes from the display interface and input the numerical codes into a phone interface or secondary computer with a display to successfully establish or reset a pin number, password, user ID, or other data. Furthermore, the same display interface with randomizing two or three-digit codes may be used for entering a second password or pin. By separating the input interface, in this case a phone, from the display interface from a computerized device, users would be able to add yet another layer of protection for accessing extremely sensitive data or information. In this embodiment, users would enter one ID and password to access the display screen and then use the display interface with the input interface or phone interface to covertly create a secondary pin or password on the phone. As shown, a table of numbers, letters, and symbols are associated with a two or three-digit numerical code which forms an encryption key schedule. The user views the key schedule to determine the sequence or two or three-digit numerical codes to enter, in order for the system to pass on the corresponding sequence of numbers, letters, and symbols which make up the newly selected pin or password, etc., or the user's login credentials.

FIG. 15 is a visual illustration of an alternative embodiment in which the user selects a type of credit card to be used on the merchant's website and each type of credit card is represented by a three-digit code, to be entered into a telephone input system.

FIG. 16 is a visual illustration of the display interface in which the user first chooses at least one predetermined indicator key to be used in a later step to input information to the system through a telephone input interface.

FIG. 17 is a visual illustration of the display interface in which the user uses the row corresponding to the predetermined indicator key to enter a credit card number into a telephone input interface.

FIG. 18 is a continuation of FIG. 17 in which digits are being entered into the system.

FIG. 19 is a continuation of FIG. 18 in which entered digits are translated for example purposes only, into credit card numbers in which the codes represent.

FIG. 20 is a visual illustration of the display interface in which two predetermined indicator keys are to be used.

FIG. 21 is a continuation of FIG. 20 in which digits are being entered into the system.

FIG. 22 is a continuation of FIG. 21 in which digits are being entered into the system.

FIG. 23 is a continuation of FIG. 22 in which entered digits are translated for example purposes only, into credit card numbers in which the codes present.

FIG. 24 is a visual illustration of an alternative embodiment in which the predetermined indicator keys are colors as opposed to humanoid figures.

FIG. 25 is a visual illustration of the display interface following FIG. 24 in which the rows of digits are uniquely colored. The user uses the row of digits that is colored in accordance to his or her selection of the predetermined indicator key in a preceding step.

FIG. 26 is a visual illustration of the display interface following FIG. 25 in which the four-digit code has been fully entered into the system.

FIG. 27 is a visual illustration of an alternative embodiment in which the digits 0-9 are represented by a single-digit code.

FIG. 28 is a visual illustration of the display interface following FIG. 27 in which one out of the four codes has been entered.

FIG. 29 is a visual illustration of the display interface following FIG. 28 in which two out of the four codes have been entered.

FIG. 30 is a visual illustration of the display interface following FIG. 29 in which three out of the four codes have been entered.

FIG. 31 is a visual illustration of the display interface following FIG. 30 in which four out of the four codes have been entered.

For purposes of clarity and brevity, like elements and components will bear the same designations and numbering throughout the figures.

### DETAIL DESCRIPTIONS OF THE INVENTION

All illustrations of the drawings are for the purpose of describing selected versions of the present invention and are not intended to limit the scope of the present invention.

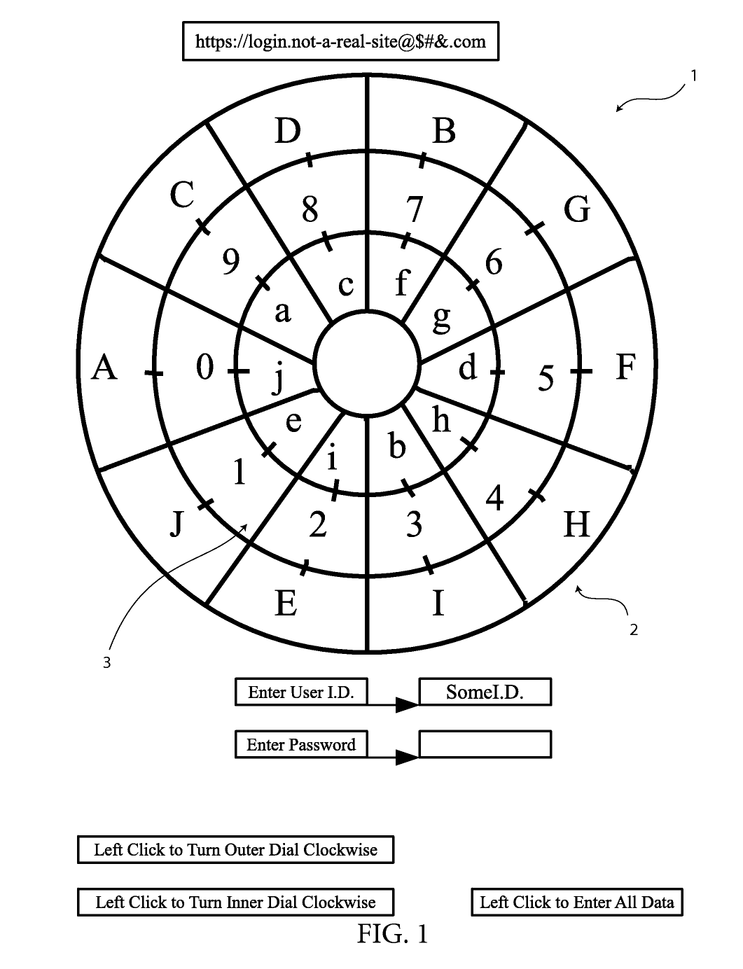

In reference to FIG. 1 shows an arrangement of indicator keys and data values 1. The arrangement is in the form of a data encryption dial with one outer compartmentalized ring loaded with indicator keys 2, one middle compartmentalized ring loaded with data values 3, and one inner compartmentalized ring loaded with an additional set of indicator keys 2. This data encryption dial is configured to work on a fictional bank's website, which is displaying the dial prior to the first data encryption and input event, which is the entering of a password. In this configuration, the data encryption dial contains three rings, the outer compartmentalized ring, the middle compartmentalized ring, and the inner compartmentalized ring. Both the outer ring and the inner ring contain indicator keys 2 which have their positions randomized and shuffled after each data encryption and input event. Also, the outer ring and inner rings may be programmed to spin and shuffle the indicator keys 2 when the user first sees the arrangement of indicator keys and data values 1. Only one indicator key per ring is a valid indicator key 21, and only the host and the user know which one is valid as the valid indicator key 21 is the means used by the host for decrypting the encrypted password. Users must have first preselected one or more specific indicator keys 2 to become valid indicator keys 21. User turns one or more of the dials until the indicator marks of the validated indicator key 21 is brought into apposition with the data value targeted for encryption and input. In the case of FIG. 1, which is for demonstration purposes, the password of the user would be any sequence of numbers zero through nine. However, the data encryption system may be configured so that the data values 3 are any combination of upper or lower case English alphabetic letters, numbers, special characters, special shapes, colors, or any computer keyboard character. Any distinguishable mark or shape that can fit inside one of the compartments of the rings can be used as an indicator key. In addition, the system could be configured to contain multiple dials, as many as could be reasonably displayed on the viewing screen or monitor.

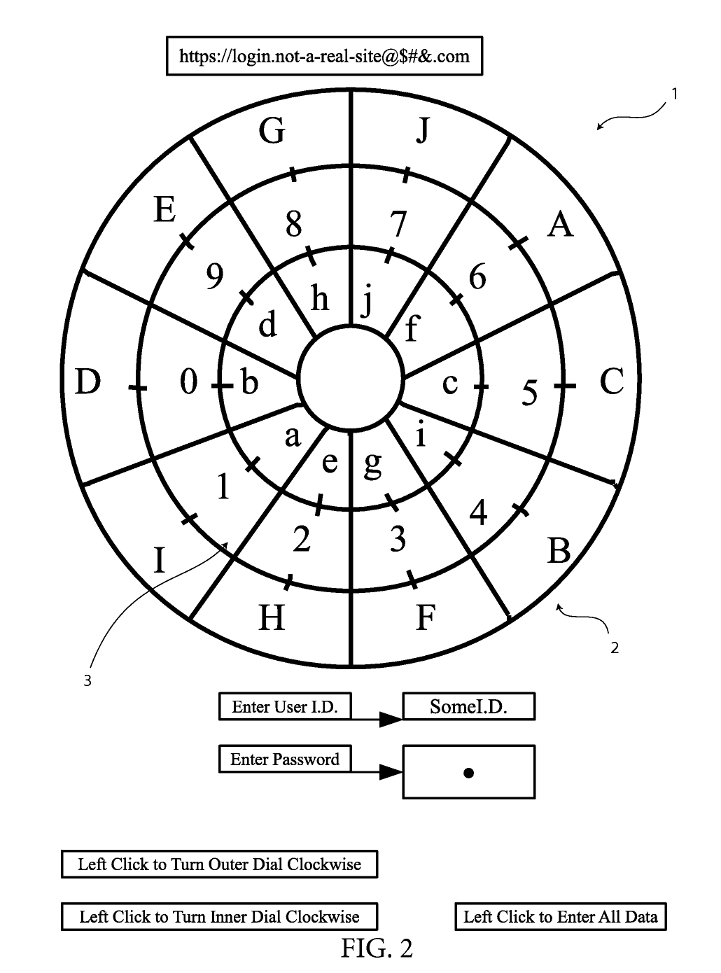

FIG. 2 is a front view of a continuation of FIG. 1 as it is the same data encryption dial configured for the website of the same fictional bank but after the first character of the password has been encrypted and inputted and after the positions of the indicator keys 2 have been shuffled and randomized so that the dial is ready for the next encryption and input event. A dot or asterisk is seen in the input field which represents that the first digit of the password has been submitted along with all non-valid indicators 22 and all non-target data 32, which requires the host to use the valid predefined indicator keys to decrypt and isolate the target data from all non-target data. In comparison to FIG. 1, the indicator keys 2 of the outer compartmentalized ring and the inner compartmentalized ring have been shuffled randomly in position. In doing so, an onlooker of the interface cannot simply memorize the positioning of the indicator keys 2 aligning with the numerical digits to re-create the correct combination of indicator keys 2 and numerical digits. Randomizing the positions of the indicator keys 2 and/or numerical digits forces the user to know the predetermined indicator key and match it with the correct numerical digit which forms the user's pin number.

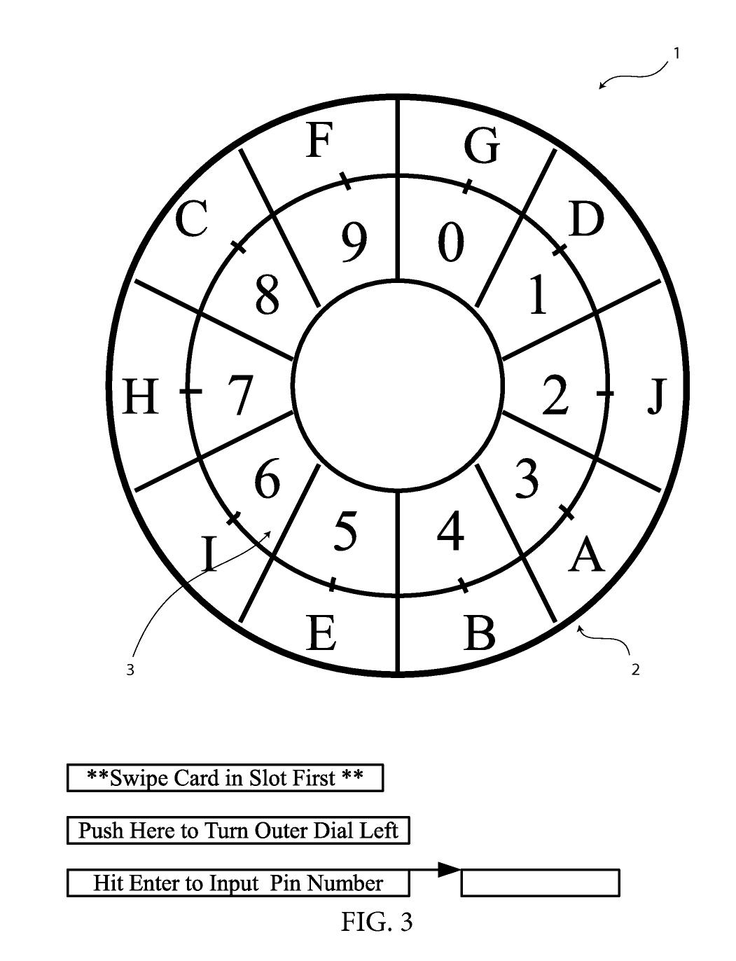

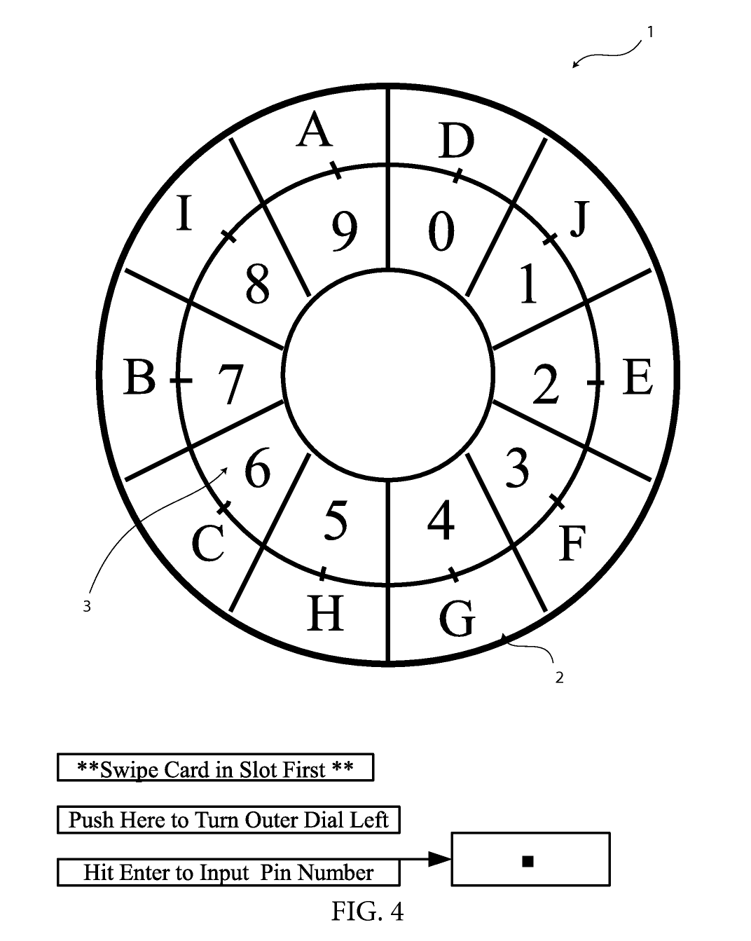

FIG. 3 is a front view of the same data encryption dial as shown in FIGS. 1 and 2, configured for the display screen of an automated teller machine after the consumer or user has swiped their check debit card. The dial is ready for the first data encryption and input event. In this configuration, the inner compartmentalized dial contains data values 2 which are the numbers zero through nine, which the user selects from to enter their pin number. The outer compartmentalized dial contains indicator keys 2 which is predetermined between the user and the bank system. The user inputs his or her card pin number by aligning the first predetermined indicator key with the first digit of the pin number and hits enter to pass the first digit to the system. After the first digit is passed, the indicator keys 2 and numerical data values shuffle position randomly and allow the user to input the second digit of his or her pin number in similar fashion as the first. For a four-digit pin number, the interface may be established so that the user uses the same predetermined indicator key for each pin number or alternatively, the predetermined indicator key may be unique for each sequential numerical data value that must be entered as part of the pin number. Exemplified in FIG. 4, the data encryption dial has indicator keys 2 that have been shuffled after the user inputted the first data value. The first data value of the pin number can be seen entered into the system, represented by a dot or an asterisk. In addition to the first data value, all invalid combinations of data values 3 and indicator keys 2 are inputted as well so as to add complexity and encryption. The system is now ready for the user to enter the second digit of the pin number. As shown in FIG. 4, the data encryption dial now has two sets of compartmentalized rings whereas in the previous step as seen in FIGS. 1 and 2, the data encryption dial comprised of three sets of compartmentalized rings. This example shows the flexibility of the present invention to increase and decrease complexity and difficulty for identity thieves to uncover the login credentials of the user for protection of more highly prized and valued data. As desired by the display interface 6, the interface can be programmed so that the first numerical value entered used a wheel with only one set of indicator keys. However, when entering the second numerical value, the encryption dial may change to have two sets of indicator keys 2 by adding an extra numerical ring. With two sets of indicator keys 2, the user must match two predetermined indicator keys correctly with the correct digit of the numerical value in order to successfully pass the numerical value as the next digit of the pin number.

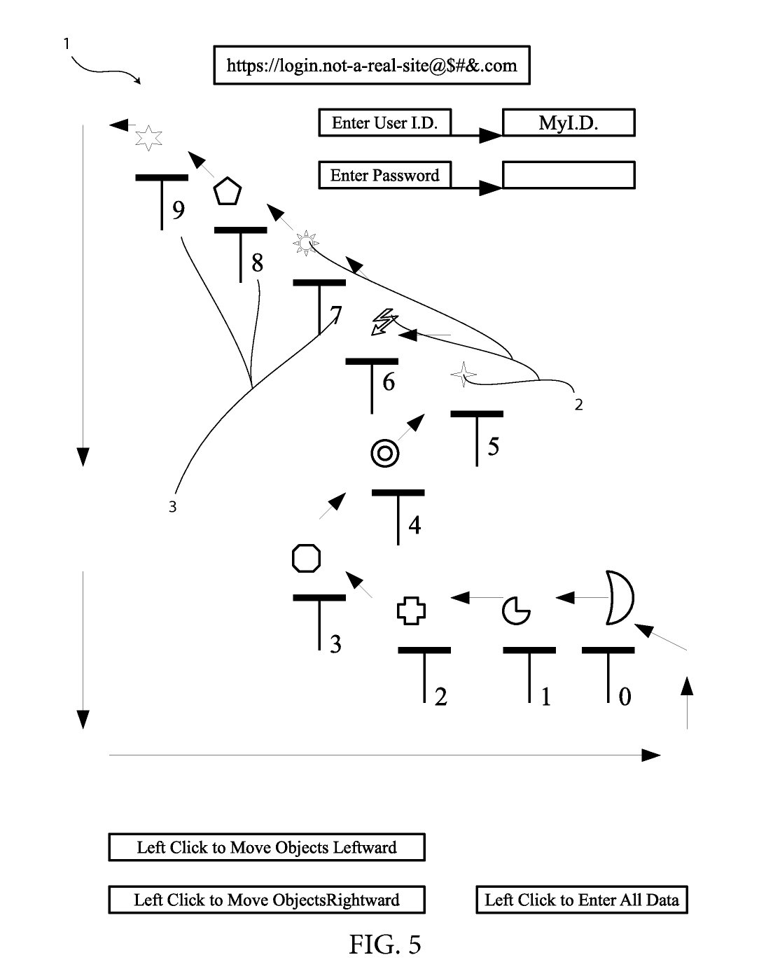

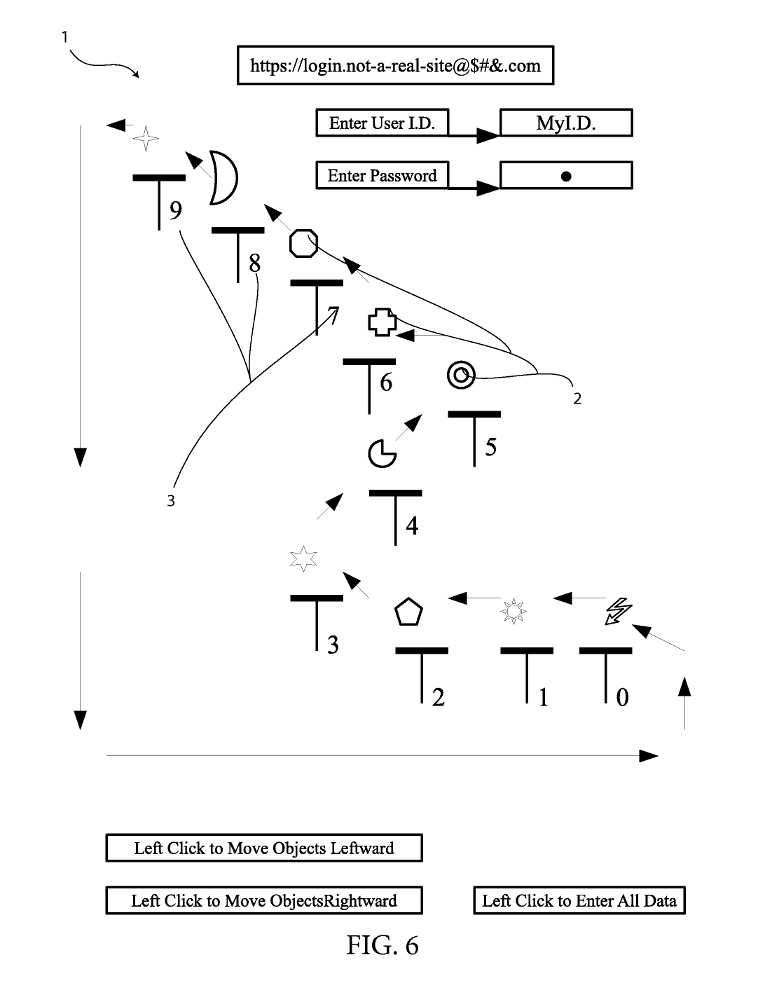

FIG. 5 is a different arrangement of indicator keys and data values 1 of the present invention and is configured to operate as the sign-in page of an internet website while using a non-circular configuration with a counter clockwise circulation of the indicator keys 2 prior to the first data encryption event. FIG. 6 is a front view of a continuation of FIG. 5 as the same data encryption device but after the first character of the password had been encrypted and inputted to the host website and after the positions of the indicator keys 2 had been shuffled and randomized. The device is ready for the second character of the password. In such exemplified interface, indicator keys 2 are brought into affiliation with a numerical data value to be passed as a digit of the pin number by moving the indicator keys 2 left or right in a zigzag or ladder design movement. With reference to FIG. 6, the lightning symbol indicator key is positioned above the numerical value ‘0’. If the user presses the trigger to move objects leftward, the lightning symbol indicator key moves one position to the left to be positioned above the numerical value ‘1’. However, if the user presses the trigger to move objects rightward, the lightning symbol indicator key moves one position to the right which would result it in ending up at the top of the ladder design and positioned above the numerical value ‘9’. In similar fashion to embodiments which utilize an encryption dial interface, the interface as shown in FIG. 5 and FIG. 6 require the user to bring a predetermined indicator key into apposition with a numerical value to be passed as a digit of the pin number required by the login interface.

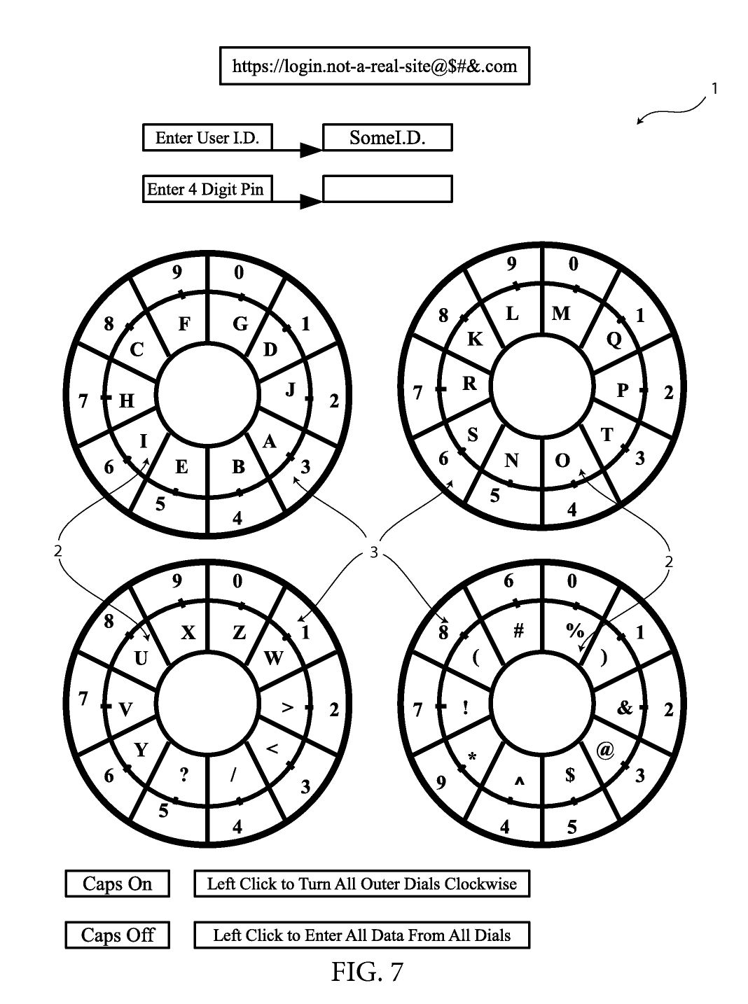

FIG. 7 is an embodiment of the present invention in which the display interface 6 presents a different arrangement of indicator keys and data values 1 of four separate data encryption dials, each with an outer compartmentalized ring and an inner compartmentalized ring. A set of data values 3 is positioned on the outer compartmentalized ring and a set of indicator keys 2 are positioned on the inner compartmentalized ring. This configuration may be used in any suitable interface where as exemplified in FIG. 7, the dials are presented on a website with a secure login web address. Input queries are presented to prompt the user to enter their website user ID and a four-digit pin number. The user inputs their user ID into a user ID field and subsequently uses the encryption dial interface of the present invention to enter in the user's unique four-digit pin number into a pin number field. To utilize this embodiment, the user turns the dials in a clockwise or counterclockwise direction to rotate the outer compartmentalized ring and subsequently, the data values 3. As shown in FIG. 7, the user clicks on a clockwise trigger button which rotates all four outer compartmentalized rings one position clockwise. Each subsequent click of the clockwise trigger button further rotates the compartmentalized rings one position clockwise with no limitation. In an alternative embodiment, a counterclockwise trigger button may be positioned which when clicked will rotate the compartmentalized rings one position counterclockwise. A caps on button is positioned so that if clicked, all of the letters of the indicator keys 2 positioned on the inner compartmentalized ring change to or maintain as upper cased characters. A caps off button is positioned so that if clicked, all of the letters of the indicator keys 2 positioned on the inner compartmentalized ring changes to or maintains as lower cased characters. Also, if the caps off button is checked, the keyboard special characters, such as ‘#, $, %’ will convert to their respective numerical digits, such as ‘#’ converts to ‘3,’ while ‘$’ converts to ‘4’ and so on. A user inputs the first digit of their pin number by aligning their pre-determined indicator key with the first digit of their pin number. For example, if the pre-determined indicator key is ‘W’ and the first digit of the pin number is ‘3’, the user must click the clockwise trigger button twice to position the ‘3’ on the lower left encryption dial to align with the pin number ‘3’, a valid indicator key-target data value pair 4. The rest of the non-valid indicator keys 22 aligned with the rest of the non-target data values 32 are a non-valid indicator key-data value pair 5. The user would then enter the data to be submitted to the website by clicking the data submission button. As the website knows the pre-determined indicator key is ‘W’, the website will know that the pin number being entered is the ‘3’ which is aligned with the indicator key ‘W’ when the data submission button is clicked. After the first pin number digit is entered, the user would then align the pre-determined indicator key ‘W’ with the next digit of the user's pin number followed by clicking of the data submission button. By having four separate encryption dials, an onlooker of the user entering in his or her pin number would have increase difficulty in comprehending which indicator key and pin number is being used by the user. Essentially, only one dial is being utilized by the user to enter his or her pin number with the remaining encryption dials as dummy dials. However, the configuration as described can also be used with a sequence of indicator keys 2 as opposed to simply one indicator key. For example, the valid indicator key 21 to enter the first digit of the pin number may be ‘W’ whereas the valid indicator key 21 to enter the second digit of the pin number may be ‘H’. In this situation, in order for the user to enter the second digit of the pin number, the user must watch the upper left encryption dial and rotate the outer compartmentalized ring so that the ‘H’ indicator key aligns with the second digit of his or her pin number. Subsequently, the indicator key used to enter the third and fourth digit of the user's pin number may be changed to add further difficulty for an onlooker of the user's screen to determine which dial is being used, which indicator key is being used, and therefore the number being entered as the pin number. Similar to previous embodiments, after each submission of a digit of the pin number, the indicator keys and pin numbers on the dials may each or both randomize in position. This furthermore increases difficulty for an onlooker of the user's screen to determine the order of indicator keys 2 being used and digits being entered as the pin number.

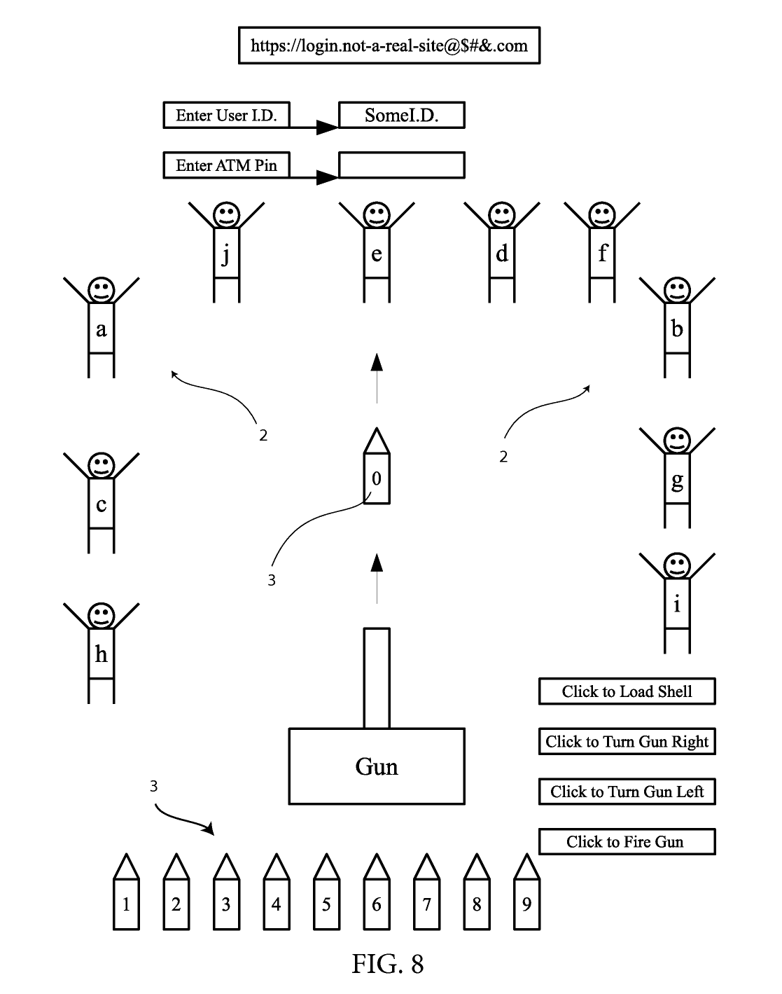

FIG. 8 is an embodiment of the present invention in which the arrangement of indicator keys and data values 1 is designed to simulate a shooting game. The exemplified implementation is again for a website login page on the internet with website address and requiring the user to enter input queries with user ID field and pin number field. In this embodiment, the user controls a gun which shoots bullets numbered with data values 3 for a pin number towards targets with an indicator key on each target. In order to successfully enter one data value of the pin number, the user must fire all 10 bullets which contain data values 0 to 9. To enter the data values 3 of the pin number, the user must fire the bullet with the target data value 31 to be entered to the target with the pre-determined indicator key. For example, if the first digit of the pin number is ‘3’ and the first pre-determined indicator key is ‘B’, the user would need to ensure that the bullet with the number ‘3’ is fired at the target with the ‘B’ indicator key. All other remaining bullets with data values 0, 1, 2, 4, 5, 6, 7, 8, 9 can be fired at any other target with an indicator key that is not ‘B’. As the system knows the pre-determined indicator key is ‘B’, it will process the data value that is fired to the target with the indicator key ‘B’ as the first data value of the pin number sequence. After the first set of bullets is fired, the targets and bullets are reset with the indicator keys 2 on the targets randomized in order. The user then subsequently fires the next set of 10 bullets ensuring that the second data value of the pin number to be entered is fired at the target with the pre-determined indicator key for the second data value of the pin number. The pre-determined indicator key may remain constant for all four data values of the pin number or it may change for each of the four data values of the pin number.

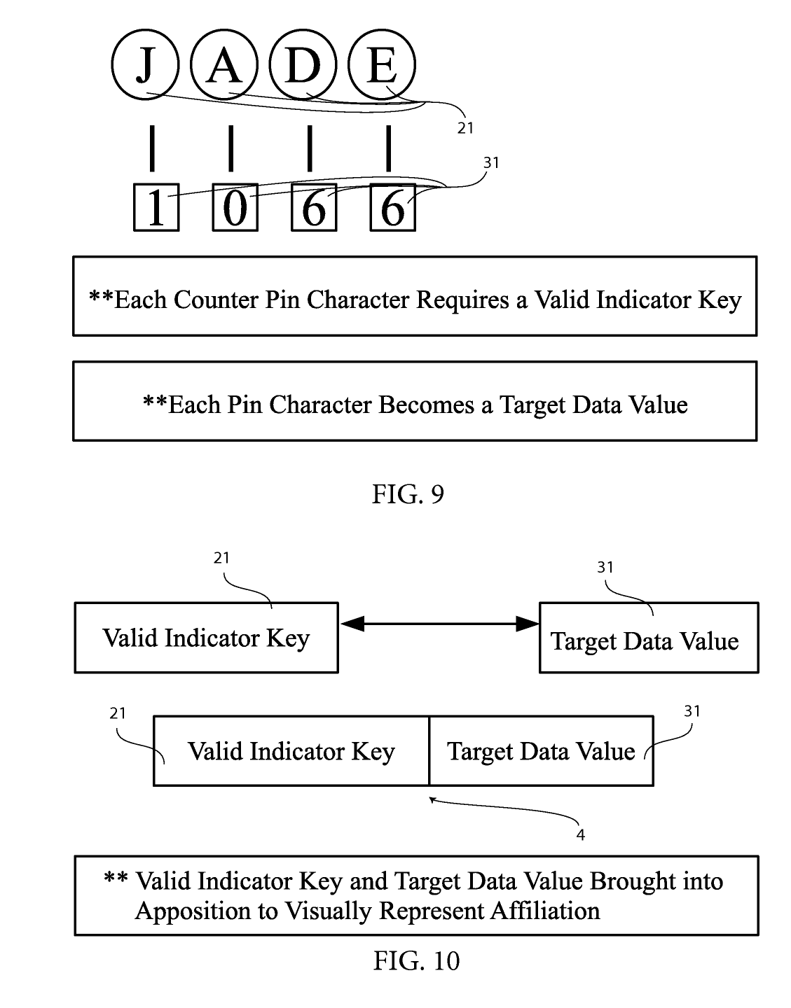

FIG. 9 visually shows the relationship between the valid indicator keys 21, also known as a counter pin, with a pin number. The valid indicator keys 21 are predetermined by the user. As shown, the present invention runs on the principal that a pre-determined indicator key associated with a pin number determines the pin number digit to be passed as a digit of the pin number. ‘J’ is the first valid indicator key 21 and is aligned to the number ‘1’ to pass the digit ‘1’. ‘A’ is the second valid indicator key 21 and is aligned to the number ‘0’. ‘D’ is the third valid indicator key 21 and is aligned to the number ‘6’. ‘E’ is the fourth valid indicator key 21 and is aligned to the number ‘6’.

FIG. 10 visually shows the relationship between a valid indicator key 21 and a target data value 31, such as a pin number. As shown, the relationship between a valid indicator key 21 and the target data value 31 can be established if the two are brought into apposition, creating a valid indicator key-target data value pair 4. In an interface utilizing the present invention, if a valid indicator key 21 is positioned by the user next to a target data value 31, the target data value 31 is passed as input to a system query.

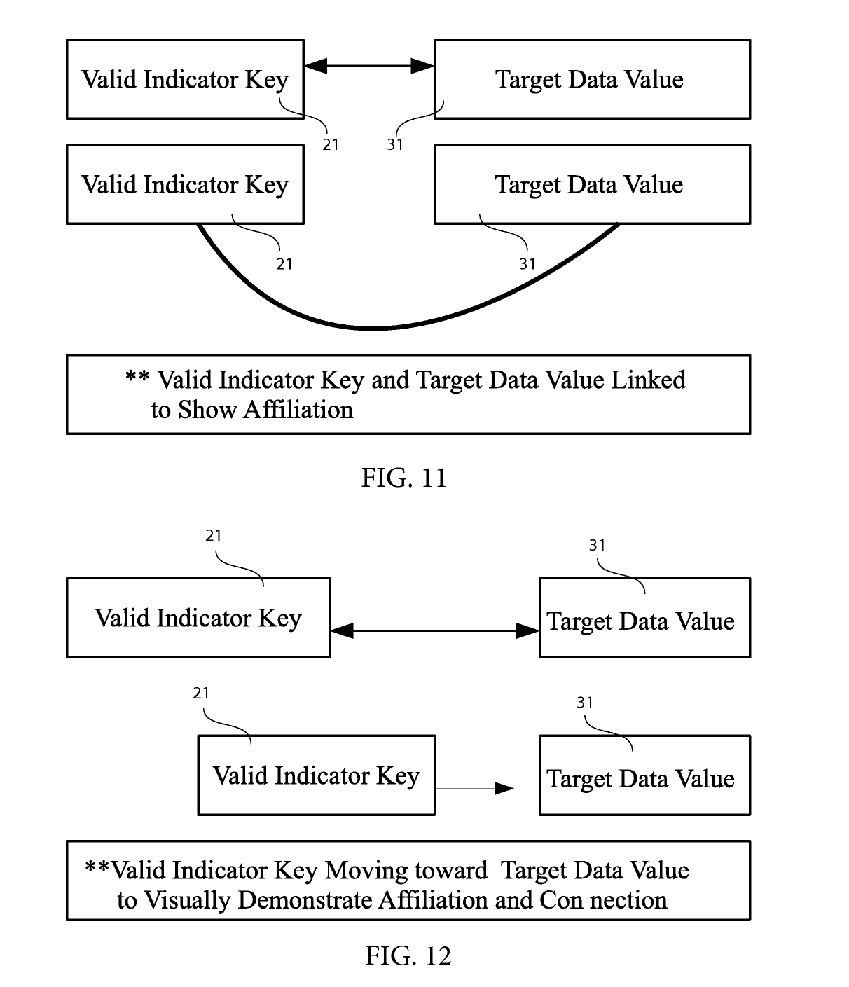

FIG. 11 visually shows the relationship between a valid indicator key 21 and a target data value 31. As shown, the relationship between a valid indicator key 21 and a target value 31 can be established if the two are linked together. For example, a user may be able to draw a line between the valid indicator key 21 and the target data value 31 to establish the connection and allow the target data value 31 to be decrypted following its input to a system query along with all other links conjoining non-valid indicator keys 22 with non-target data values 32. The user will also have to draw a line between non-valid indicator keys 22 and target data 32 not to be decrypted but passed as invalid input. By connecting all indicator keys 2 with target data values 31 as well as non-target data values 32, an onlooker of the interface will be unable to determine which data value is being targeted for encryption without knowing the pre-determined valid indicator key.

FIG. 12 visually shows the relationship between an predetermined and thus valid indicator key 21 and a target data value 31. As shown, the relationship between a valid indicator key 21 and a target data value 31 can be established if the one or both are moved towards the other. For example, in a game interface in which target data values 21 and non-target data values 32 are toy cars and non-valid as well as valid indicator keys 22, 21 are different points of destination, the user may simply move the toy car in the direction of the indicator key and the display interface 6 will continue to move the toy car in the same trajectory as originally set by the user until the toy car reaches its final destination with corresponding indicator key. The relationship between valid indicator key 21 and target data value 31 can therefore be established without a physical link but rather, simply directing one towards the position of the other.

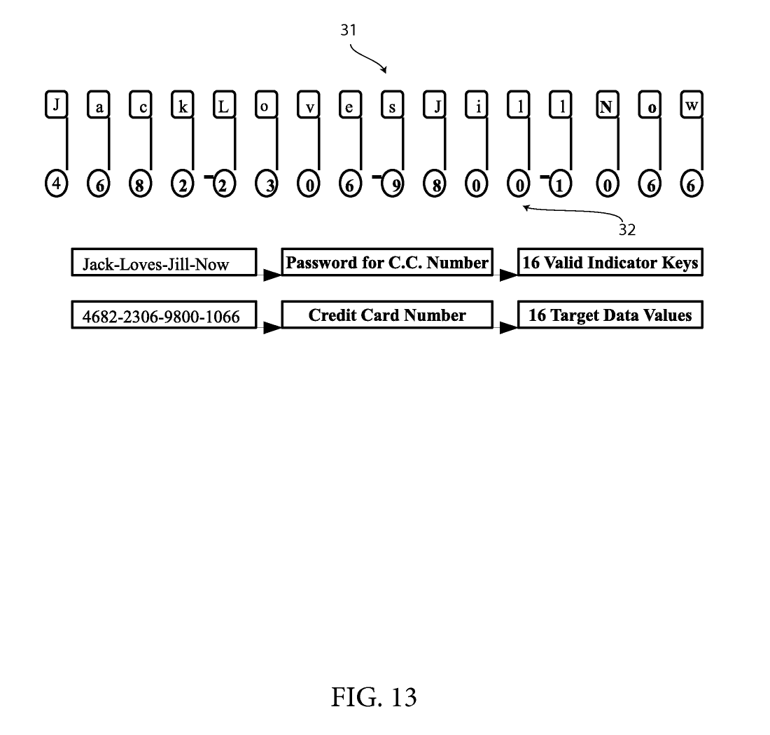

FIG. 13 visually shows the relationship between a set of predetermined and thus valid indicator keys 21 and a set of target data values 31. As shown, the user is prompted to input 16 values. In this embodiment, the pre-determined indicator key changes for each of the 16-digits to be entered. In order to facilitate memorization of the sequential order of the correct indicator key to be used, the sequence of indicator keys forms a memorable phrase. In the example, the sequence of indicator keys forms the phrase ‘Jack Loves Jill Now’. Any type of interface may be utilized to create the relationship between indicator key and data value such as apposition, connection, directional movement or any other reasonable method of affiliation. Regardless of method, the user must affiliate the ‘J’ indicator key with the first digit of the credit card number to be entered, which in the present example is ‘4’. Subsequently, the user must affiliate the ‘a’ indicator key with the second digit of the credit card number to be entered, ‘6’. Following, the user must affiliate the ‘c’ indicator key with the third digit of the credit card number to be entered, as shown is ‘8’. The user would then continue to use indicator keys 2 which form the pre-determined indicator key phrase ‘Jack Loves Jill Now’ to affiliate data values to be passed as the requested credit card number.

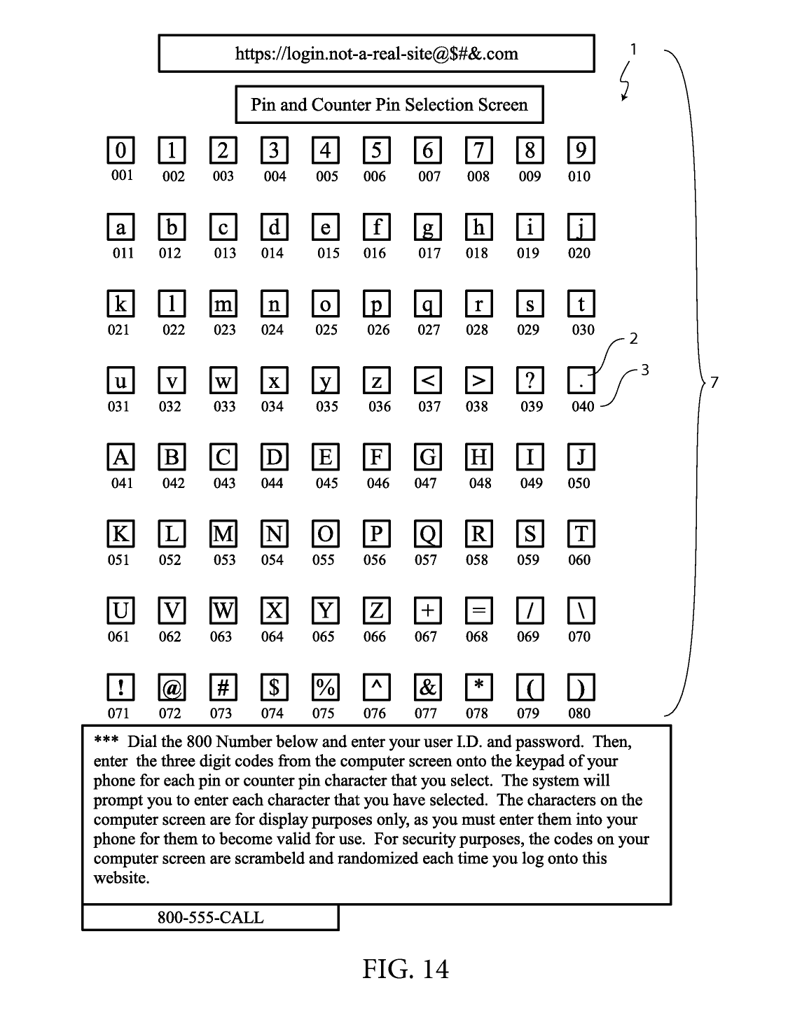

FIG. 14 is an embodiment of the present invention in which the interface presents an encryption table, allowing the user to input information through dialing digits on a touch-tone telephone. Each number, letter, and symbol on a traditional keyboard is assigned a two or three-digit number which can be entered into a telephone. Also, the encryption table can easily be configured to show non-keyboard marks and symbols. Even bar codes of varying width or a series of dots and various shapes could be shown with two or three-digit numbers below them. The three-digit number to dial is positioned on the chart immediately below the digit or character in which it corresponds to. As shown, for a user to input the number ‘0’, the user would dial ‘001’ on their telephone. Further exemplified, ‘011’ enters ‘a’, ‘021’ enters ‘k’, ‘035’ enters ‘y’, ‘045’ enters ‘E’, ‘069’ enters ‘/’, etc. This interface increases security of information input for a website as it separates the display interface with the data input interface. The user attempting to login to the website is viewing the website from a computer screen. However, entering of a username and password to access the website is completed through a phone interface, an input interface 7. Users may also select another option or embodiment to use the encryption table for creating, setting, or resetting pin numbers, counter pin numbers, passwords or counter credit card numbers. By separating the display interface 7 and input interface 6, it becomes more difficult for an identity thief to obtain the credentials as entered by the user. Onlookers watching the user will be unable to determine the information inputted by watching the display interface 6 as no identifiable information is presented on the display interface 6. Furthermore, key loggers or other spyware software on the user's computer would be unable to steal the inputted information of the user as no information is actually entered through the computer but rather through the input interface 7. With each unique visit to the website, the three-digit code associated with each unique digit or letter randomizes so as to not remain constant. This requires the user to enter a different series of three-digit codes for each visit even if the login credentials remain the same. By doing so, even if the user's phone is tapped by an identity thief who intercepts the sequence of three-digit codes entered by the user, the information will not be useful as the same sequence will not enter the same series of login credentials the next time. The website interface knows the unique associations of three-digit codes to numbers and characters which are valid for one login attempt only. Upon a new login session, the three-digit number associates are randomized so that any previous sequence of three-digit numbers will not yield the correct login credentials.

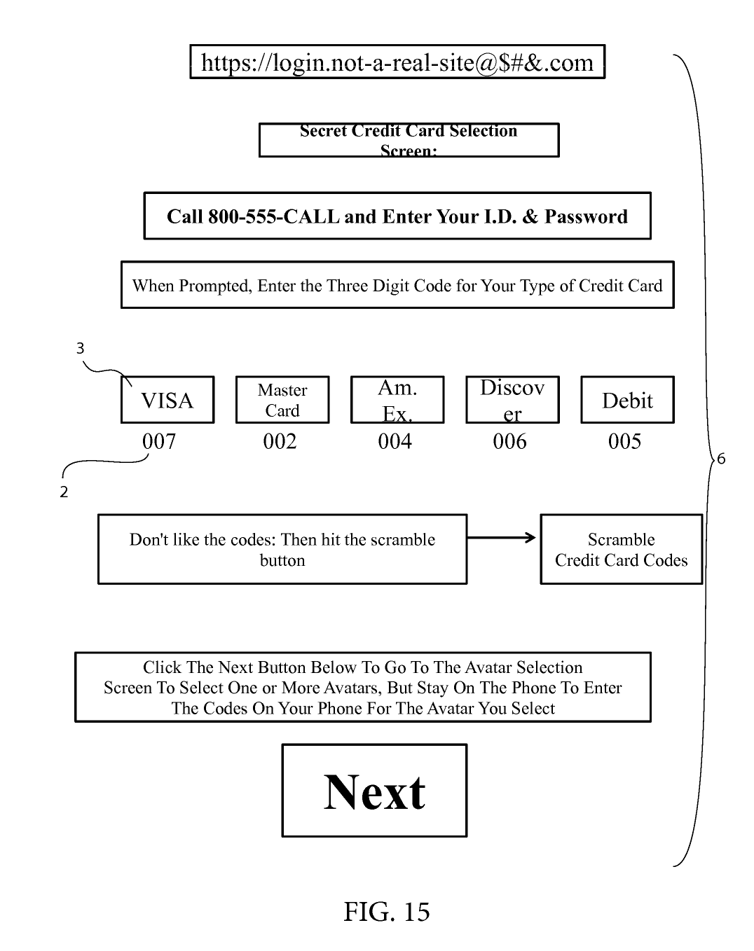

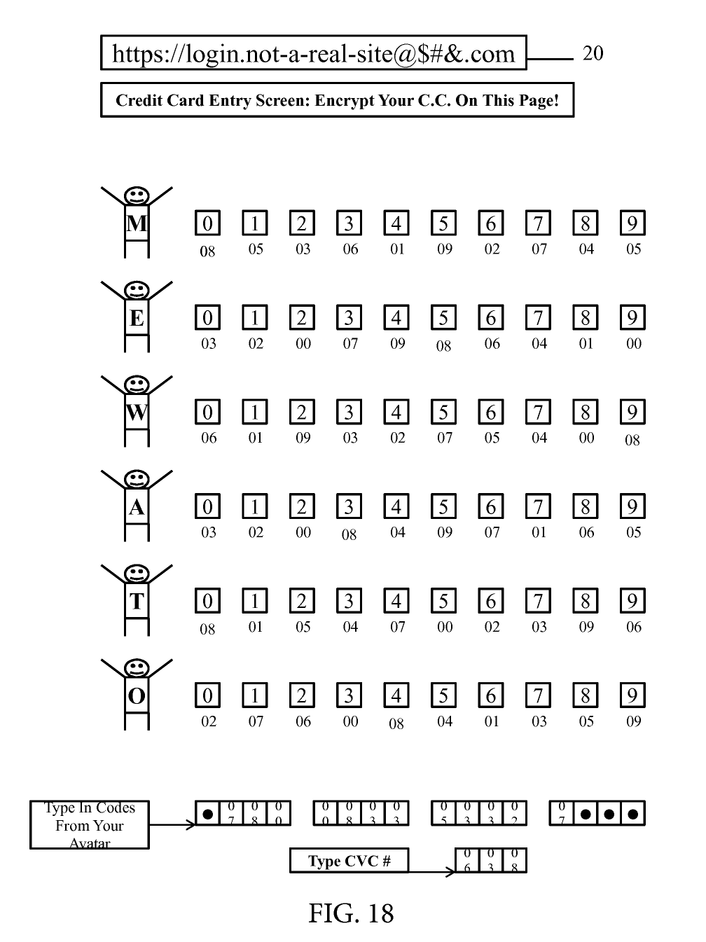

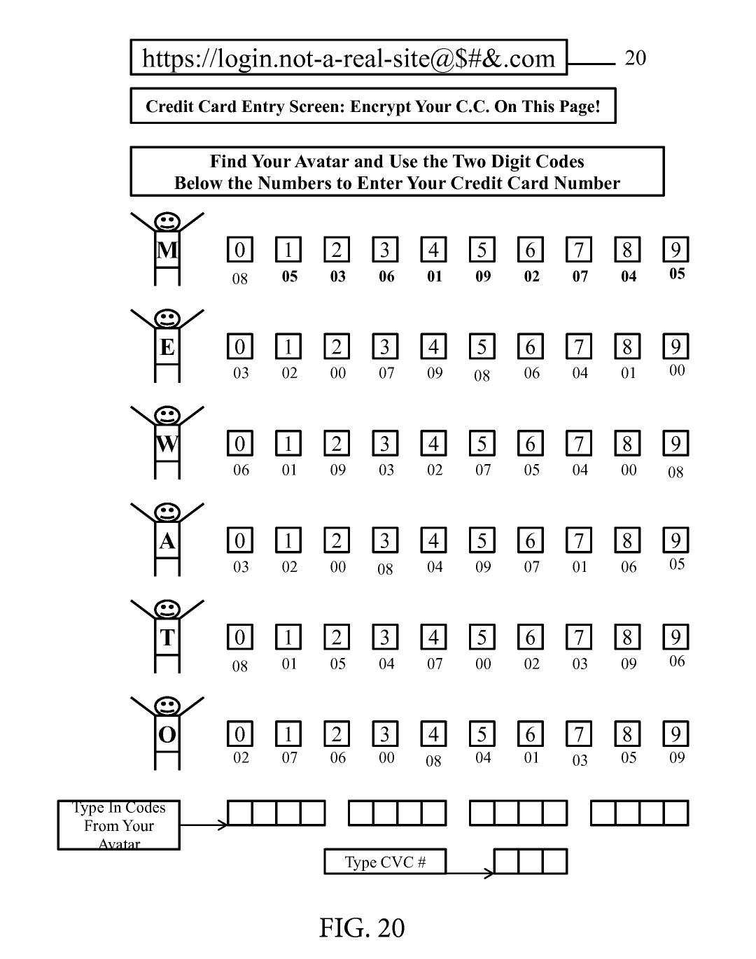

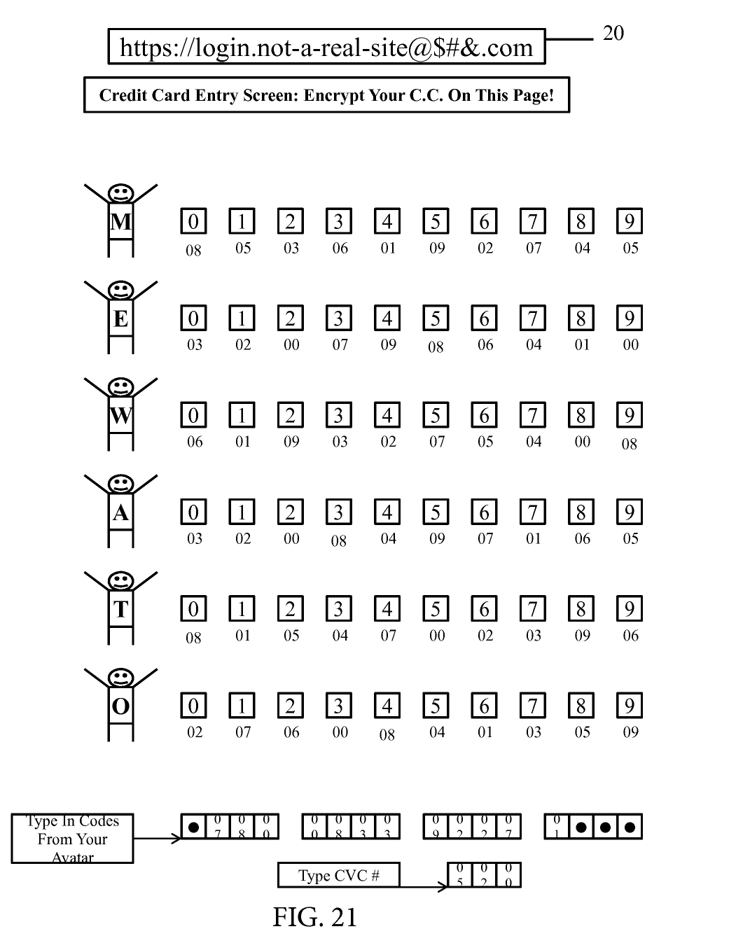

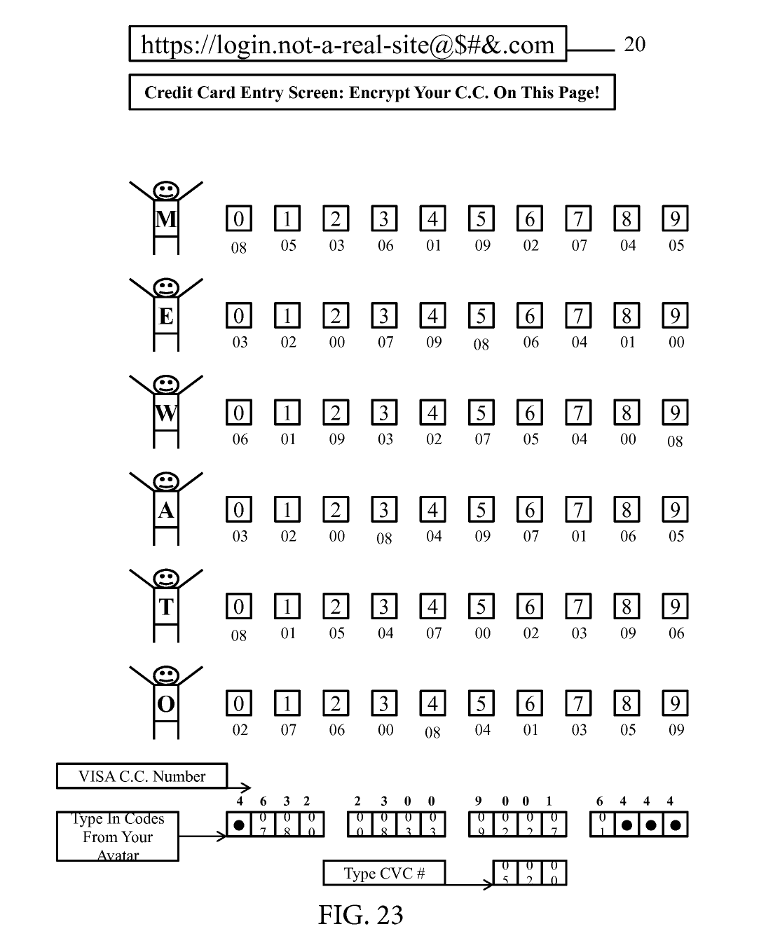

In reference to FIG. 15 to FIG. 26, an alternative embodiment of the present invention is presented, which utilizes a pool of avatars 8 containing a specific type of indicator key 2 represented by labeled characters, also known as avatars. Although any distinguishable mark, symbol, feature, color, or any combination of these options may be used as the indicator keys 2, for the presentation of this embodiment, labeled characters known as avatars are shown. In the first prompt screen of the embodiment as shown in FIG. 15, the user must specify to the prompt system the issuing company of the credit card that is to be used at the merchant's website. As shown, the merchant accepts Visa, MasterCard, American Express, Discover, or debit card which are indicated on the sample display interface 6. Below each issuing company name, a three-digit code is associated with each brand allowing the user to indicate using the displayed codes which type of credit card will be used. For the user to specify the credit card brand to be used, he or she calls the phone interface by dialing a displayed phone number. Calling the system prompts the user to enter the three-digit code that is associated with the credit card brand the user intends to use. For example, if the user wishes to use a Visa card, he or she would enter 007 as shown in the example of FIG. 15. Alternatively, if the user wishes to use a MasterCard, he or should would enter 002; 004 represents American Express, 006 for Discover, and 005 for Debit card. Requiring that the user input responses to the system through an input interface 7 allows for the separation of input interface 7 and display interface 6. It is not enough for an identity thief to be able to solely see the display interface 6 or solely intercept the data transmitted by phone by the user through the input interface 7. Simply seeing the display interface 6 will allow the identity thief to know which three-digit key is associated with which credit card issuer. However, this information is useless without knowing which selection is entered by the user. Furthermore, simply knowing which digits are dialed by the user into the input interface 7 will allow the identity thief to know which three digits are entered. However, this information is useless without also knowing which card type is associated with the three digits that are entered. Furthermore, for a third party to determine the card issuer entered by the user, the third party must have access to both the display interface 6 and the input interface 7 at the same moment in time. Every time the display interface 6 is loaded, the three digits which are associated with each brand issuer is shuffled or randomized to different digits. This further decreases the likelihood for an identity thief to gain possession of the type of card that is inputted. With such a system, not only does an identity thief have to intercept the digits that are entered by the user through the input interface 7, the identity thief must also have access to the display interface 6 screen at the moment that the digits are entered into the input interface 7 by the user. Once digits are entered into the input interface 7 by the user or the display interface 6 is refreshed or reloaded by the user, the digits associated with each credit card issuer will change making any intercepted digits in possession by the identity thief irrelevant and useless. In an event where the user believes the current instance of the display interface 6 has been viewed by or compromised by an onlooker or identity thief, the user can manually scramble the three-digit codes associated with each card issuer on demand by clicking a scramble button. When triggered, the button instructs the system to randomly scramble the three-digit codes associated with each card brand or reassign new randomly generated codes to each.

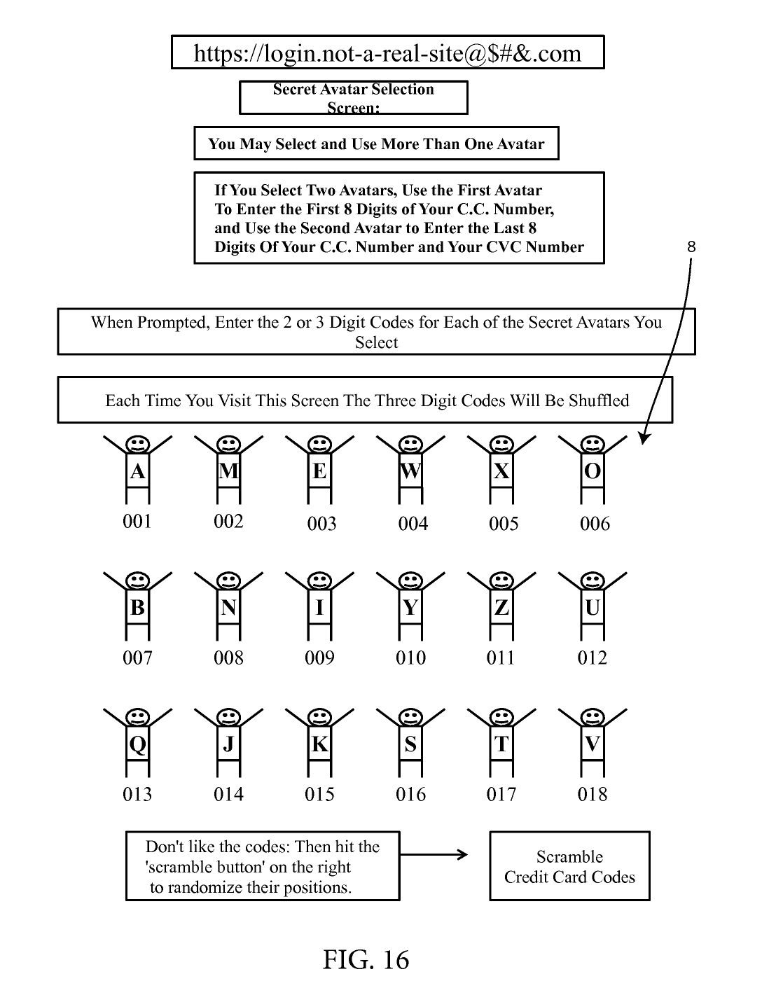

Once the user has inputted to the system the credit card issuer, the system will proceed to collect the actual credit card numbers and security CVC number from the user. In the preferred embodiment as shown in FIG. 16, the interface prompts the user to select a group 81 of at least one target avatar 811 from the provided pool of avatars 8. Avatars can also be referenced as company specified trade names to contribute to the theme of the user experience. In the exemplified embodiment as shown in FIG. 16, the avatars are humanoid figures with a unique letter on each figure. Below each figure, a three-digit number is associated with each. The user is prompted to select a group 81 of one or more avatars by entering the associated three-digit numbers into the phone input interface. In similarity to the process described previously allowing the user to enter their card issuer brand, the current process to select one or more avatars increases the difficulty in which an onlooker or identity thief can determine which specific avatar or avatars are chosen by the user. The three-digit codes associated with each indicator key randomizes after each instance of using the telephone input interface 7, the display interface 6 is reloaded, or the scramble codes button is manually invoked.

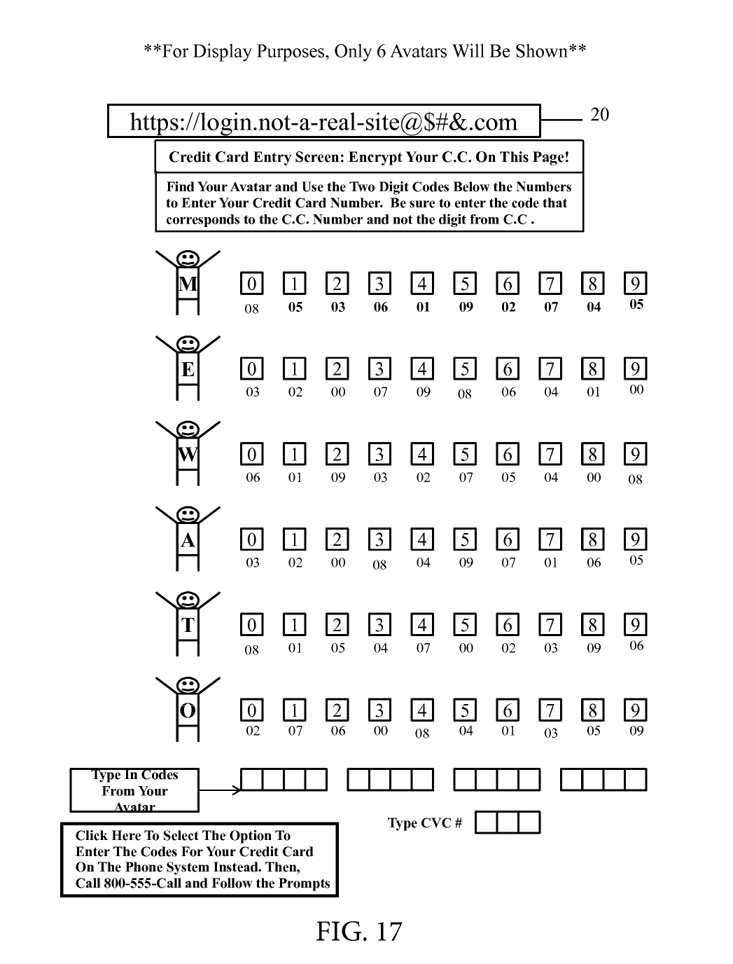

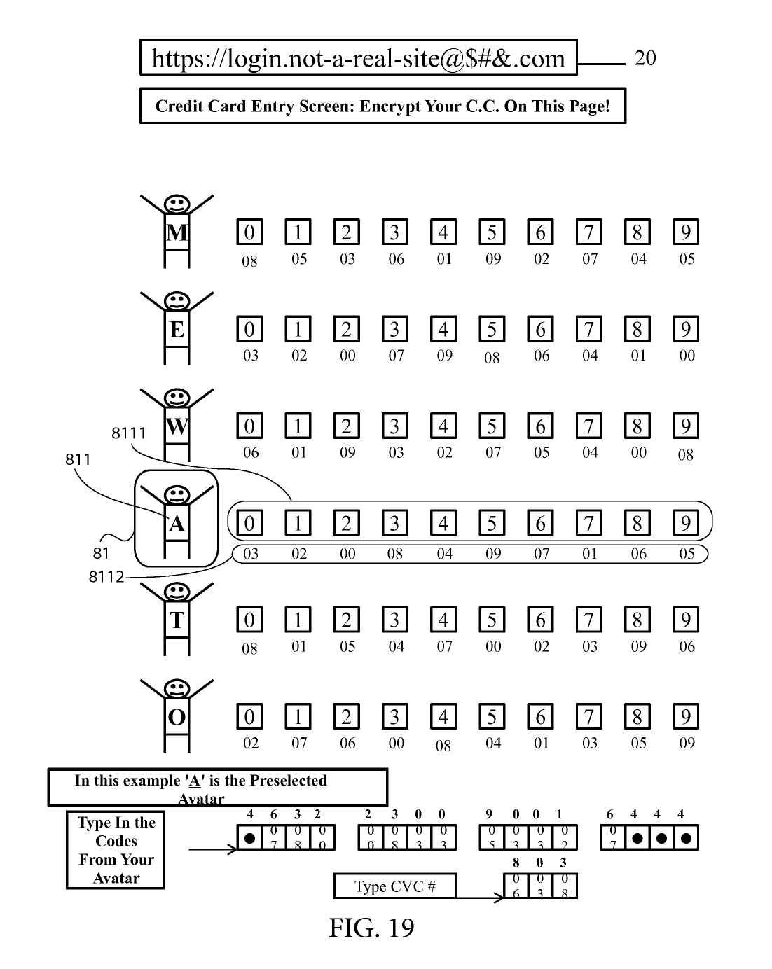

As seen in FIG. 17, the next screen of the preferred embodiment prompts the user to provide the credit card number and CVC code to be used with the merchant's website. In similarity to previous steps, the user inputs information through the telephone input interface 7 and data to be entered is represented by digits which are randomized and shuffled at defined intervals or invoked manually. As shown, a plurality of rows is shown with each row having the digits 0-9 in each row. Below each digit, a two-digit number is positioned and associated which is entered by the user to represent the digit of his or her credit card number to be inputted. For ease and efficiency, the host may select the option to use a single-digit code when the data is only numerical values 0-9. In this particular embodiment though, the two-digit codes allows for the expansion of data values to include alphabetic characters or special characters. Preceding each row of digits 0-9, one target avatar 811 is positioned to represent the adjacent row of digits 0-9. The row containing target data values 31 adjacent to the target avatar is called a data value set 8111. The digits underneath each data value in the data value set comprise a code set 8112. The user uses the indicator keys to determine which data value set 8111 he or she should be viewing and used to input codes into the telephone input system. Using the example in FIG. 17, the first row of digits or the data value set 8111 is associated with the humanoid figure indicator key ‘M’, the second row is associated with the humanoid figure indicator key ‘E’, and the third row is associated with the humanoid figure indicator key ‘W’. Assuming the use selected indicator key ‘A’ as the predefined indicator key in the previous step of the process, the user would focus on the row adjacent to and represented by the humanoid indicator key ‘A’, in this example being the 4^{th} row. As seen in FIG. 19, the first four digits of the user's credit card number are 4632. To enter in the first digit 4, the user finds the digit 4 in the fourth row of digits as indicated by his predefined indicator key, the humanoid with the letter ‘A’. Looking at this row, the user can see that the digit 4 is represented by the two-digit code ‘04’. The user would input ‘04’ into the telephone input interface. Following, the second digit of the user's credit card being 6, the user would see that the digit 6 is associated with the two-digit code of ‘07’ and proceed to subsequently enter in ‘07’ into the telephone input interface 7. The user would continue these steps to fully enter his 16-digit credit card number along with three digits for his CVC code. As the user inputs digits for his credit card number, the system may be defined to shuffle or randomize certain elements of the display interface 6 to make it more difficult for an onlooker or identity thief to decipher which codes are being entered or which is the valid indicator key 21 as chosen by the user. The location of the target avatar 811 may shuffle in arrangement in addition to the shuffling of two-digit codes which represent each credit card digit for every row. As defined by the system, shuffling of target avatar(s) 811 or two-digit codes may occur as often as after each successful input of a credit card digit into the telephone input interface, or periodically after a batch of credit card digits are inputted. By increasing the frequency of shuffling, the system becomes more difficult for an identity thief to determine which row is being used by the user, which indicator key is the predetermined indicator key, and ultimately what the credit card digits of the user are. However, a drawback of increasing the frequency of shuffling is complexity for the user and length of time required for the user to input data. With each reshuffling of indicator keys 2 or target avatar(s) 811, the user must spend time to relocate his predefined indicator key and its associated row of digits 0-9 in order to continue inputting codes associated with this credit card number.

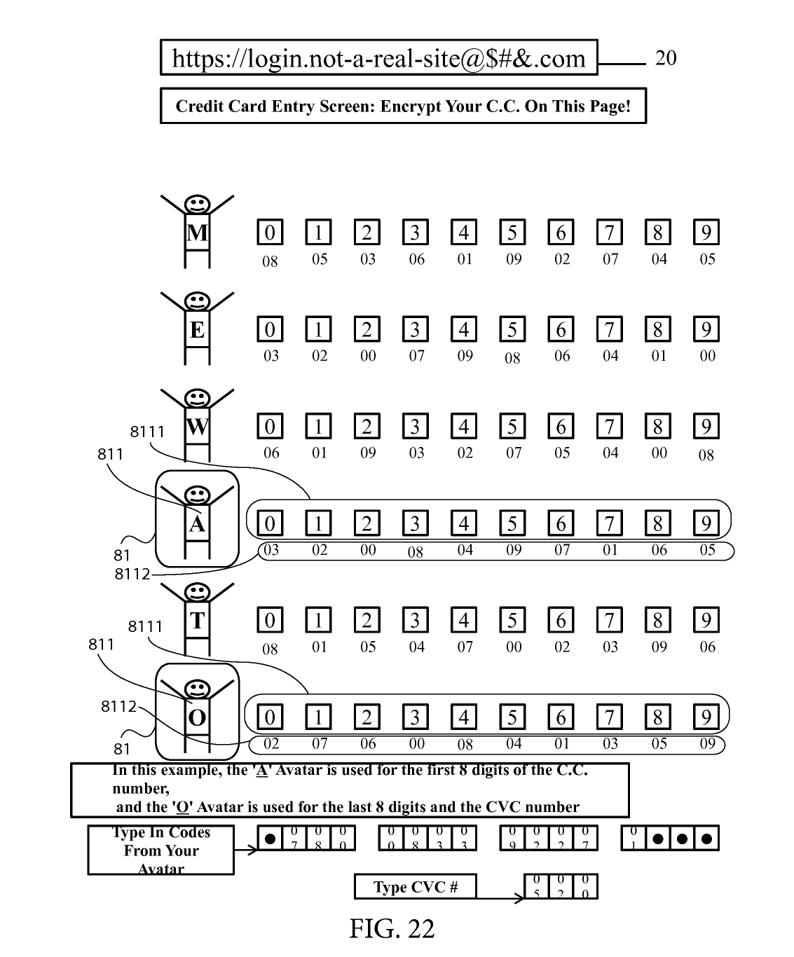

With reference to FIG. 22, the user selected two predetermined valid indicator keys 2, also known as avatars 811, to be used. In this situation, the total of 16 digits of the user's credit card is distributed so that the first eight of those digits are entered by using the first predetermined valid indicator key and the second eight of those digits are entered by using the second predetermined valid indicator key. After the credit card digits are entered by the user, the CVC number is entered by using the second predetermined valid indicator key 21. Depending on the configuration of the system by the merchant, different variations of use for the predetermined valid indicator keys can be utilized. For example, the system may require alternating uses of the predetermined indicator valid keys so that the first digit of the credit card number is entered using the first predetermined valid indicator key and the second digit of the credit card number is entered using the second predetermined valid indicator key. The use of predetermined valid indicator keys can be alternating or at a specific pattern that is programmed into the system. Although complex pattern use of predetermined valid indicator keys increases the security of the system to reduce the chances an onlooker or identity thief can determine the actual credit card numbers of the user, it also increases the complexity for the user and may make it difficult for the user to properly enter in their credit card number.

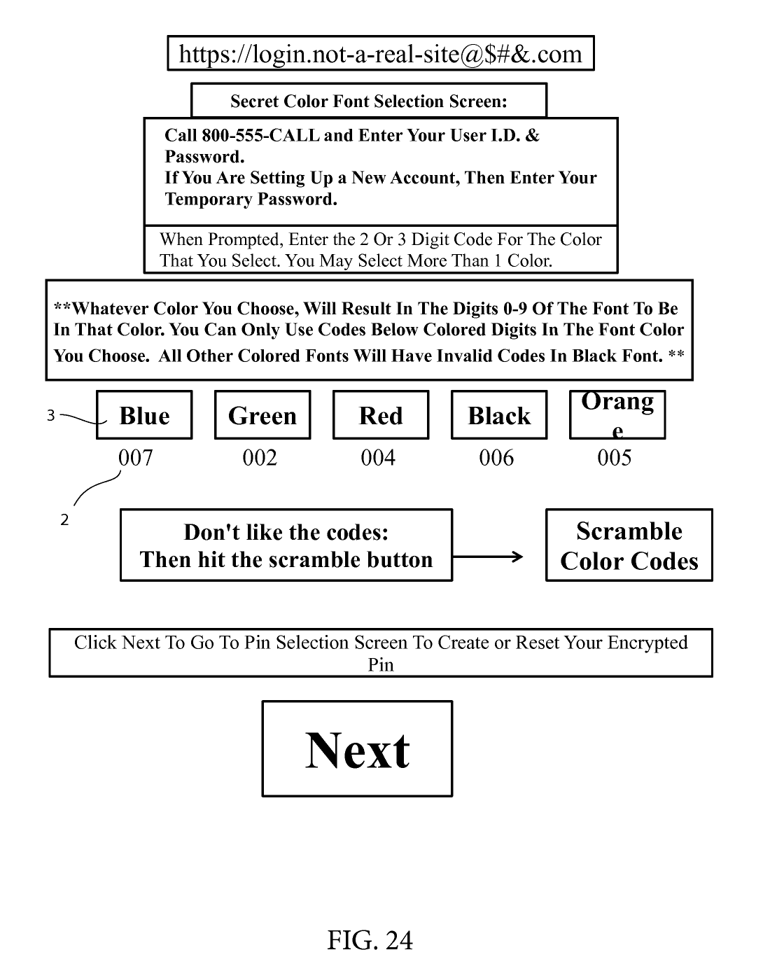

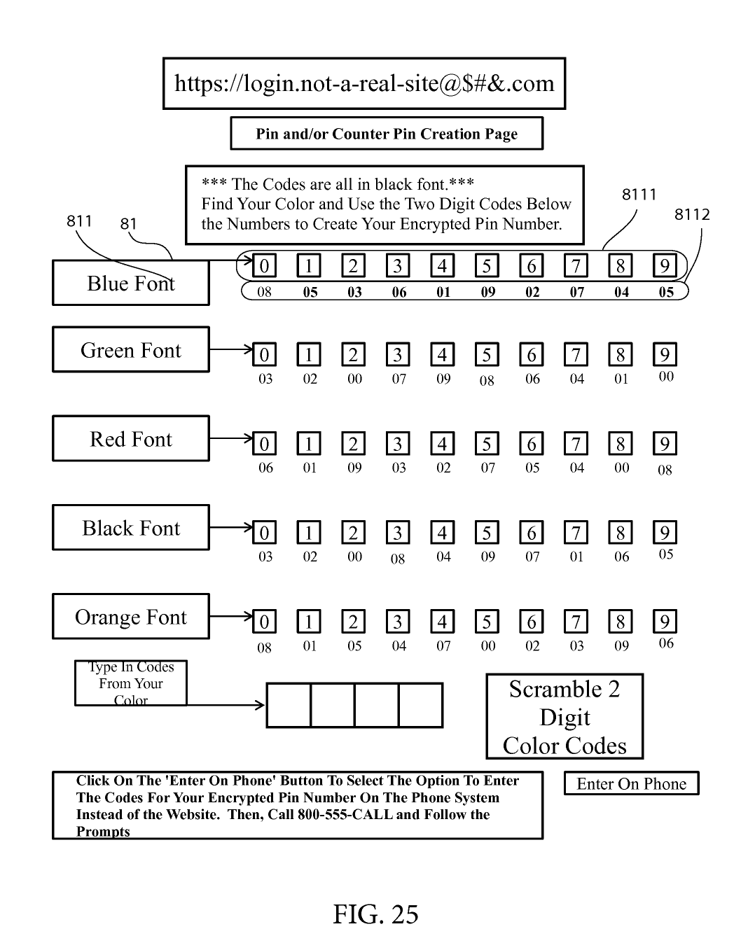

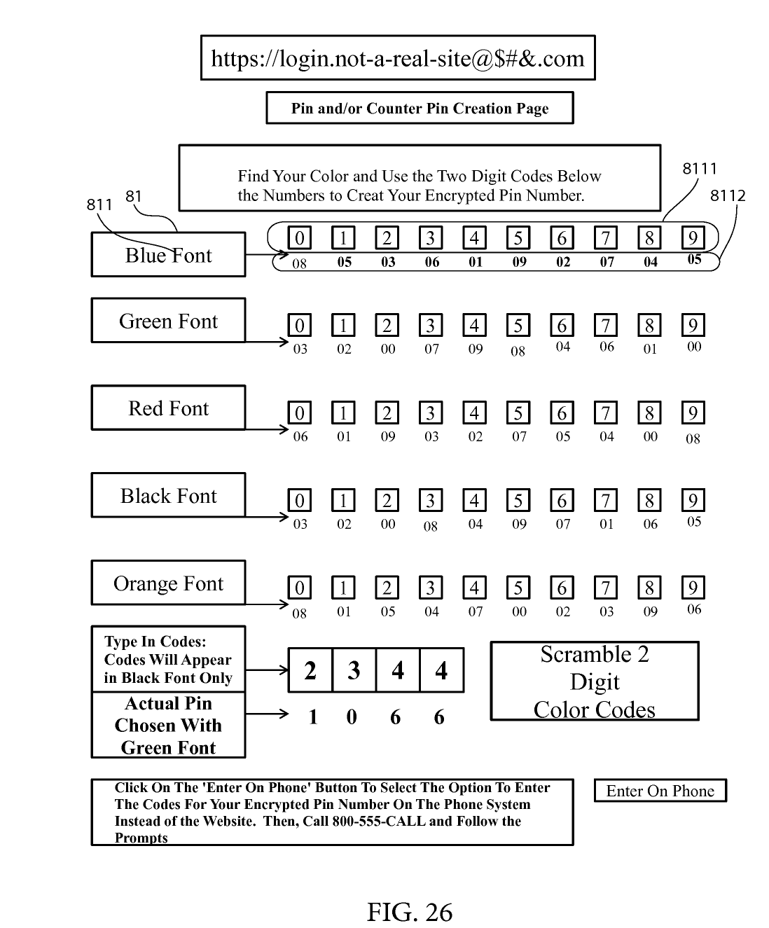

In alternative embodiments, the predetermined valid indicator key is not represented by humanoids or avatars but may also be represented by other distinguishing elements such as symbols or colors. As seen in FIG. 24, an alternative embodiment is presented in which the row of valid indicator keys 21 are represented by the colors blue, green, red, black, and orange. Following, on FIG. 25 and FIG. 26, it is seen that the user uses the row of digits 0-9 as determined by the color of the digits in that row. The user uses the row in which the color of the digits matches the color as originally chosen to be the predetermined valid indicator key in the preceding step.

For the current embodiment, a combination of one or more interfaces may be used. If more than one interface is used, then, the possibility of cyber theft is reduced, since thieves or hackers would have to hack into both interfaces simultaneously. Also, the interfaces are interchangeable, meaning that the display interface 6 may be displayed on a computer screen or a smart phone with the input interface 7 on the other. If the display interface 6 is displayed on the smart phone, then the input interface 7 would be utilized on the computer and vice versa.

Although a one-digit code is more efficient for the user to enter quickly, for the present embodiment, two-digit codes are displayed so that letters and special characters may be added to the list of numbers that are functioning as target data and non-target data. For example, English alphabetic values a-z may be added to the line of numbers, so as to incorporate letter based passwords to the data. With this addition, two-digit codes would be required due to the number of characters added.

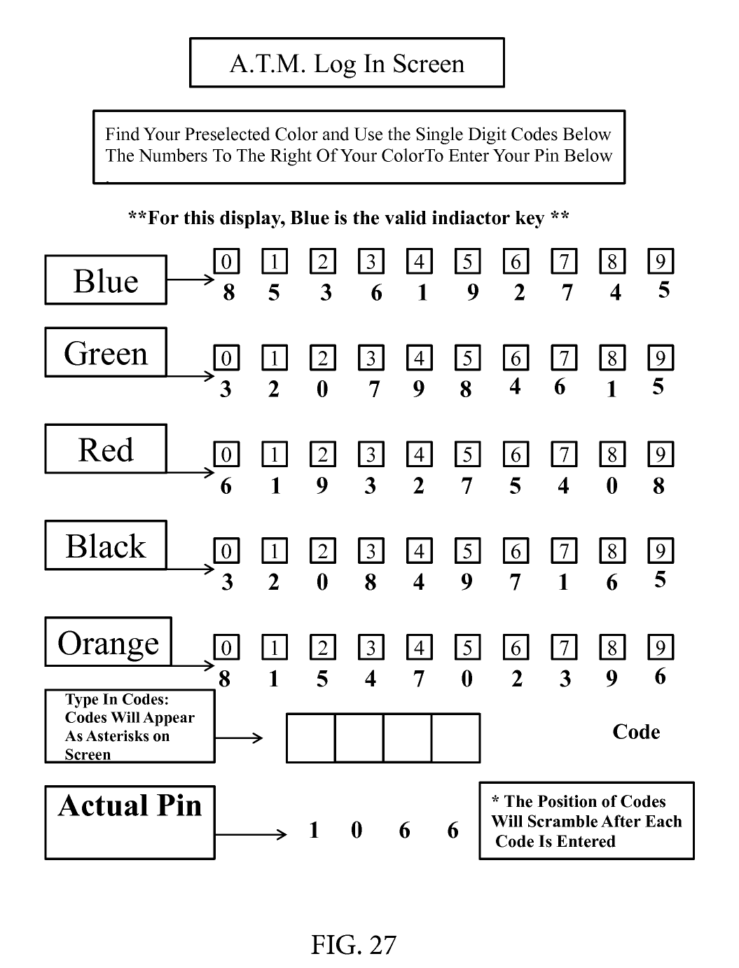

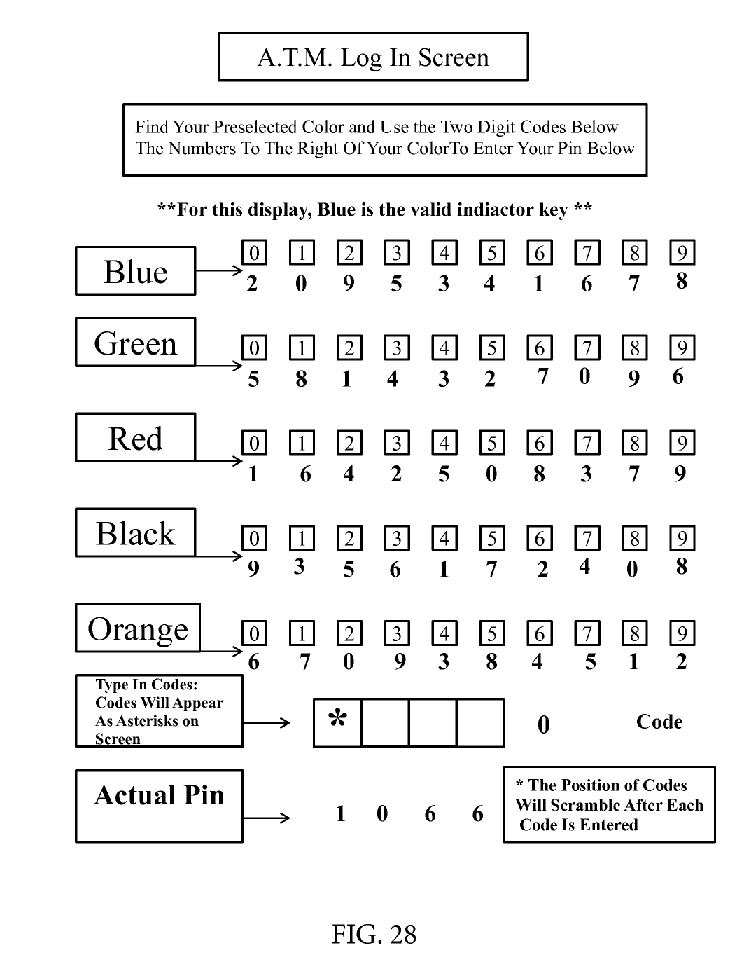

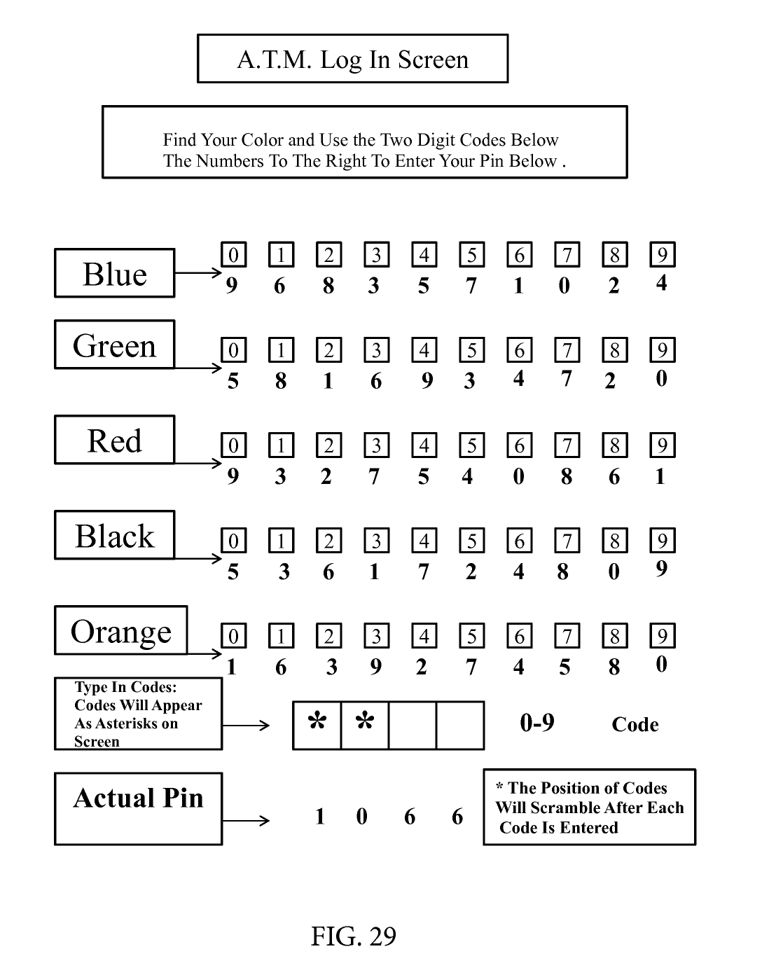

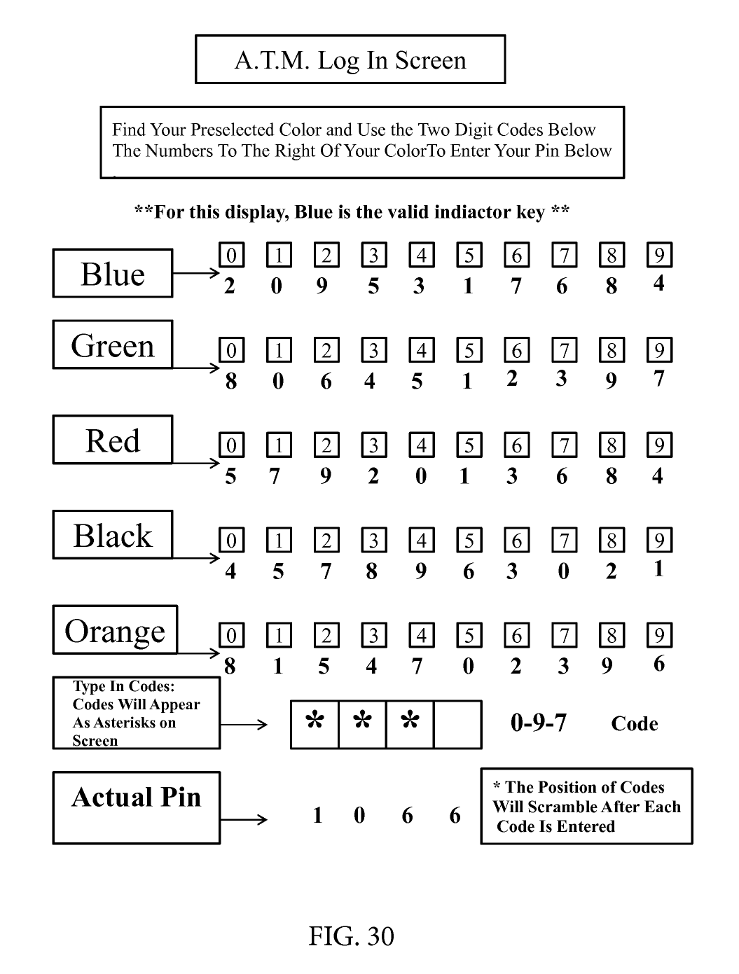

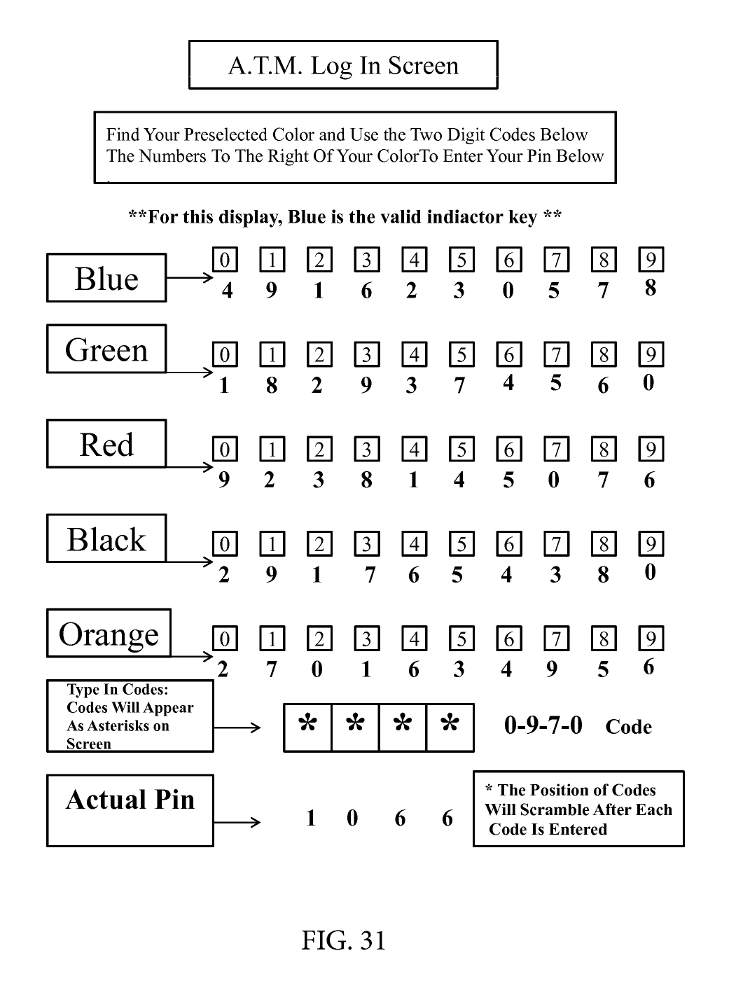

In reference to FIG. 27, a one-digit code is assigned to each digit 0-9 per row as opposed to having a three-digit code per digit. This allows for faster inputting of information by the user. In the exemplified figure, the system requires a four-digit pin number from the user and uses the system to display codes to the user and requires the user to input the codes through a phone input interface. In this embodiment, there is no preceding step in which the user uses the system to select at least one predetermined valid indicator key. Instead, the predetermined valid indicator key, being a color in this embodiment, is predetermined and understood between the user and the merchant using the system. If used by a bank, the customer of the bank has a predetermined color valid indicator key that is established with the bank directly. The user knows to use this color as the predetermined valid indicator key for the system and can change this color with the bank directly, as desired or required. FIG. 27 shows the initial screen where the no digits have been entered yet. FIG. 28 shows the next screen in which one digit has been entered to represent the first digit of the pin. Subsequently, all representative digits below each 0-9 digit in the rows have been randomized so that the next time the user comes to enter the same pin number, the code entered will be different. This prevents an identity thief from gaining access to the secured system even if the exact code that is entered in one particular session is compromised. FIG. 29 shows the screen in which two digits of the code have been entered and FIG. 30 shows the screen in which three digits of the code have been entered. Finally, FIG. 31 shows the screen in which all four digits of the code have been fully entered and ready to be submitted to the system for verification. If the code has been entered correctly and matches the correct pin number of the user, the user is granted access and proceeds to the secured portion of the website.

The present invention is not limited to interfacing with human users whereas the method may be applied to system to system communication. For example, an automated system may communicate with the data encryption and input system in order to upload or download data from a protected source. The encryption system will digitally communicate the positioning of one or more encryption dials. The automated system may then communicate back how the compartmentalized rings should be turned and when data should be passed. In such an implementation, the present invention may be utilized as a method of system to system authentication.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the invention has been explained in relation to its preferred embodiment, it is to be understood that many other possible modifications and variations can be made without departing from the spirit and scope of the invention as hereinafter claimed.

What is claimed is:

1. A method for data encryption, comprising steps of:
(1) showing an arrangement of indicator keys and data values;
(2) user matching a valid indicator key to a target data value and non-valid indicator keys to non-target data values;
(3) inputting valid indicator key-target data value pair along with the non-valid indicator key-non-target data value pairs;
(4) comparing and verifying inputted valid indicator key-target data value pairs to server-stored valid indicator key-target data value pairs; and,
(5) shuffling of indicator keys.

2. The method for data encryption claim 1 comprises, repeating the encryption process until all target data values are inputted.

3. The method of claim 1, wherein the indicator keys are a unique distinguishable character including, but not limited to letters, digits, or symbols, avatars, colors, or icons.

4. The method of claim 1, wherein the valid indicator keys are preselected and assigned to each character of the user's password, pin number, or credit card number.

5. The method of claim 1, wherein the target data value is one character of the user's password.

6. The method of claim 1, wherein the showing of the arrangement of indicator keys and data values is on a display interface.

7. The method of claim 1, wherein the inputting of valid indicator key-target data pair and non-valid indicator key-non-target data value pairs is on an input interface.

8. The method of claim 6, wherein the input interface is located in the display interface.

9. The method of claim 1, wherein the arrangement of indicator keys and data values can be displayed in an interface form selected from the group consisting of at least one dial, chart, table, or game interface.

10. A method for data encryption, comprising steps of:
(1) showing an arrangement of indicator keys and data values;
(2) user matching a valid indicator key to a target data value and non-valid indicator keys to non-target data values;
(3) inputting valid indicator key-target data value pair along with the non-valid indicator key-non-target data value pairs;
(4) comparing and verifying inputted valid indicator key-target data value pairs to server-stored valid indicator key-target data value pairs; and,
(5) shuffling of indicator keys.

11. The method for data encryption claim 10 comprises, repeating the encryption process until all target data values are inputted.

12. The method of claim 10, wherein the indicator keys are a unique distinguishable character including, but not limited to letters, digits, or symbols.

13. The method of claim 10, wherein the valid indicator keys are preselected and assigned to each character of the user's password.

14. The method of claim 10, wherein the target data value is one character of the user's password.

15. The method of claim 10, wherein the showing of the arrangement of indicator keys and data values is on a display interface.

16. The method of claim 10, wherein the inputting of valid indicator key-target data pair and non-valid indicator key-non-target data value pairs is on an input interface.

17. The method of claim 16, wherein the input interface is located on a screen separate from the display interface.

18. The method of claim 10, comprises,
selecting at least one avatar from a pool of avatars via at least one indicator key wherein each of the indicator keys are directly related to each avatar, wherein these selected avatars define a group;
selecting from the group a target avatar, wherein each avatar comprises of a data value set and a code set;
assigning each code of the code set to each data value of the data value set;
inputting target data value via the assigned code;
shuffling of each code assignment to each data value; and,
wherein the avatar is a representation selected from a group consisting of a humanoid or a font color.
